(19) United States
(12) Patent Application Publication
(10) Pub. No.: US 2022/0391975 A1
(43) Pub. Date: Dec. 8, 2022

(54) SYSTEMS AND METHODS FOR CALLABLE INSTRUMENTS VALUES DETERMINATION USING DEEP MACHINE LEARNING

(71) Applicant: Wells Fargo Bank, N.A., San Francisco, CA (US)

(72) Inventors: Jian Liang, San Francisco, CA (US); Zhe Xu, San Francisco, CA (US); Peter Li, San Francisco, CA (US)

(21) Appl. No.: 16/587,792

(22) Filed: Sep. 30, 2019

Related U.S. Application Data
(60) Provisional application No. 62/850,830, filed on May 21, 2019.

(51) Int. Cl. G06Q 40/04; G06N 3/08

(52) U.S. Cl. CPC G06Q 40/04; G06N 3/08

(57) ABSTRACT

Systems, apparatuses, methods, and computer program products are disclosed for pricing a callable instrument. A plurality of paths corresponding to the value of an underlying entity of the callable instrument are determined corresponding to a set of dates. The set of dates includes a particular exercise date of the callable instrument. A deep neural network (DNN) of a backward DNN with value reset solver is trained until a convergence requirement is satisfied. The backward DNN with value reset solver propagates in reverse time order from a final value to an initial value based on the path. At the particular exercise date, an expected value is determined and compared to criteria. If the criteria are satisfied the value of the callable instrument at the particular exercise date is set to a reset value, otherwise the value at the particular exercise date is maintained as a value determined via the propagation.

### CROSS-REFERENCE TO RELATED APPLICATIONS

This application claims priority to U.S. Application No. 62/850,830, filed May 21, 2019, the content of which is incorporated herein in its entirety by reference.

### TECHNOLOGICAL FIELD

Example embodiments of the present disclosure relate generally to the use of deep machine learning in determining the value of callable instruments and, more particularly, to systems and methods for providing the value of callable instruments in real time or near real time.

### BACKGROUND

A callable instrument is an instrument (e.g., derivative, bond, security, and/or the like) where the issuer and/or holder retains the right to redeem the instrument prior to the stated maturity date. Traditional methods for determining the value of a callable instrument at a particular point in time include finite difference based partial differential equation (PDE) methods, which are only capable of handling low dimensional problems, and Monte Carlo methods, which are computationally expensive.

### BRIEF SUMMARY

A callable instrument is an instrument where the issuer and/or holder retains the right to redeem or call the instrument prior to the stated maturity date. Determining the value of various callable instruments is not straightforward. For example, for a callable instrument having multiple exercise dates (e.g., dates on which the callable instrument may be redeemed or called), determining the value of the callable instrument at a particular time (e.g., an exercise date) includes determining both the continuation value of the callable instrument and the payoff value of the callable instrument at the particular time. Traditional methods for determining the value of callable instruments include finite difference based PDE methods, which are only capable of handling low dimensional problems, and Monte Carlo methods, which are computationally expensive. For example, when using Monte Carlo methods using a system having a reasonable amount of processing power and processing speed, the computation takes a significant amount of time. However, in situations where a decision regarding holding or calling a callable instrument must be made in a relatively short period of time, traditional methods for determining callable instruments values may be too slow for effective use.

Various embodiments provide methods, systems, apparatuses, and/or computer program products for the efficient determination of the value of callable instruments at one or more points in time. For example, various embodiments provide methods, systems, apparatuses, and/or computer program products for determining the value of callable instruments, possibly for multiple callable instruments, at a plurality of points in time (e.g., including possible exercise dates and/or call dates of the callable instruments). Various embodiments are configured to determine and provide the value of callable instruments for one or more callable instruments at one or more points in time in real time or near real time with respect to receiving a corresponding request. Various embodiments provide an interactive user interface (IUI) through which a user may cause a request for value determination to be provided and through which a user may be provided a graphical and/or tabular representation of callable instrument values for one or more callable instruments at one or more points in time.

In various embodiments, the value of the callable instrument(s) is determined using a backward deep neural network (DNN) with value reset solver. In various embodiments, the problem for determining the value of the callable instrument(s) may be posed as a partial differential equation (PDE) and/or an equivalent backward stochastic differential equation (BSDE). In various embodiments, the value of the callable instrument(s) depends on one or more underlying entities such as one or more stocks, indices (e.g., equity indices such as the SPDR S&P 500 trust (SPY) or NASDAQ 100 Trust (QQQ), for example), and/or the like. The PDE and/or BSDE may be configured to describe the evolution of the value of the callable instrument with respect to the underlying entity. In various embodiments, the backward DNN with value reset solver, through machine learning, is trained to describe the sensitivity of the value of the callable instrument to changes in the corresponding underlying entity. For example, the backward DNN with value reset solver may use the sensitivity of the value of the callable instrument to changes in the corresponding underlying entity at various points in time to determine the value of the callable instrument at various points in time. In various embodiments, the DNN of the backward DNN with value reset solver comprises a plurality of sub-networks, with each sub-network corresponding to a defined set of times {tᵢ|i=0, 1, . . . , N} (e.g., including at least one of the multiple exercise dates tₖ). Each of the sub-networks are trained simultaneously such that the value of callable instrument at multiple points in time are determined through one training of the DNN of the backward DNN with value reset solver.

In various embodiments, a training iteration of the DNN of the backward DNN with value reset solver comprises determining a final value of the callable instrument at a final time in the defined set of times (e.g., t_{N}) and projecting the value of the callable instrument backward (possibly based on an underlying entity), through one or more intermediate values corresponding to one or more intermediate times of defined set of times, back to an initial value of the callable instrument corresponding to an initial time (e.g., t₀) of the defines set of times. This backward projection is performed along a plurality of paths (e.g., Monte Carlo paths) and a set of initial values of the callable instrument are determined therefrom. A statistical measure of spread (e.g., variance, standard deviation, and/or the like) for the set of initial values is determined and the weights and/or parameters of the DNN of the backward DNN with value reset solver are modified to reduce the statistical measure of spread for the set of initial values determined on the next training iteration of backward projection for the plurality of paths. Once the DNN of the backward DNN with value reset solver satisfies a convergence requirement (e.g., the statistical measure of spread is sufficiently small and/or the number of training iterations has reached a particular number) the resulting values of the callable instrument at the various points in time are provided (e.g., for display to a user via a user computing device, stored in memory for later use, and/or the like). This backward projection of the value of the callable instrument provides the basis of the backward DNN portion of the name backward DNN with value reset solver. In various embodiments, the DNN of the backward DNN with value reset solver comprises a feedforward DNN. For example, the information within the DNN of the backward DNN with value reset solver moves from the input nodes, through the hidden nodes, and out to the output nodes without forming any cycles or loops within the network.

In various embodiments, the backward DNN with value reset solver is configured to evaluate an expected value of callable instrument with respect to one or more criteria. In various embodiments, if the expected value of the callable instrument satisfies one or more criteria, the value of the callable instrument may be reset. In various embodiments, resetting the value of the callable instrument at a possible exercise date and/or call date comprises setting the value of the callable instrument to a call value of the callable instrument at the possible exercise date and/or call date. In an example embodiment, the evaluating the one or more criteria includes comparing the expected value of the callable instrument at the possible exercise date and/or call date to the call value of the callable instrument at the possible exercise date and/or call date. In such an embodiment, the one or more criteria are satisfied when the expected value of the callable instrument at the possible exercise date and/or call date is less than the call value of the callable instrument at the possible exercise date and/or call date. In various embodiments, the expected value of the callable instrument is determined based on a least square regression of the value of the callable instrument with respect to one or more underlying entities of the callable instrument. The resetting of the value of the callable instrument provides the backward DNN with value reset solver with the second portion of its name.

The backward DNN with value reset solver allows for efficient determination of values of callable instruments at various points in time. Moreover, the backward DNN with value reset solver directly estimates the sensitivity of the value of the callable instrument to the underlying entity without introducing additional model assumptions. These features contrast with traditional means for determining values of a callable instrument. For example, traditional means for determining values of a callable instrument are computationally expensive as they require use of a Monte Carlo method using a very large number of Monte Carlo paths. For example, such Monte Carlo methods require more than a factor of ten more paths than the backward DNN with value reset solver. Additionally, such traditional methods require additional modelling of the sensitivity of the value of the callable instrument to the underlying entity, which then introduces additional model assumptions.

Accordingly, the present disclosure sets forth systems, methods, apparatuses, and computer program products that accurately and computationally efficiently determine and provide the value of one or more callable instruments at various points of time (e.g., at one or more possible exercise dates and/or call dates). There are many advantages of these and other embodiments described herein. For instance, the computational efficiency of various embodiments of the backward DNN with value reset solver described herein allows for the providing of the value of one or more callable instruments at various points of time and/or an optimal calling strategy for one or more callable instruments in real time or near real time with respect to the receipt of a request for such while still providing accurate results and/or predictions. Thus, embodiments of the backward DNN with value reset solver may be used to inform decisions on relatively short time frames. In addition, since the backward DNN with value reset solver directly determines the sensitivity of the value of the callable instrument to the underlying entity, fewer model assumptions are used to determine the value of the callable instrument at various points of time.

According to a first aspect, a method for pricing a callable instrument is provided. In an example embodiment, the method comprises defining a set of dates comprising a plurality of time-ordered dates. The set of dates comprises a particular exercise date of the callable instrument. The method further comprises determining a plurality of paths corresponding to a value of an underlying entity of the callable instrument. Each path corresponds to the set of dates. The method further comprises training a deep neural network (DNN) of a backward DNN with value reset solver until a convergence requirement is satisfied by for each path of the plurality of paths, using the backward DNN with value reset solver, determining a callable instrument value for each of the plurality of dates of the set of dates, wherein for each path (a) a final value, corresponding to a final date of the set of dates, is determined, (b) intermediate values, corresponding to the dates of the set of dates between an initial date and the final date of the set of dates, are determined in reverse time order, and (c) an initial value, corresponding to the initial date of the set of dates, is determined; defining a set of initial values comprising the initial value determined for each path and determining one or more statistical measures of spread based on the set of initial values; and modifying one or more parameters of the DNN based on the one or more statistical measures of spread. The method further comprises, when determining the intermediate values, when the intermediate value corresponding to the particular exercise date is determined, an expected value corresponding to the particular exercise date is determined and evaluated based on one or more criteria. Responsive to the expected value corresponding to the particular exercise date satisfying the one or more criteria, the intermediate value corresponding to the particular exercise date is set to a reset value. Responsive to the expected value corresponding to the particular exercise date not satisfying the one or more criteria, not modifying the intermediate value corresponding to the particular exercise date. The method further comprises after the convergence requirement is satisfied, determining pricing information for the callable instrument using the DNN; and providing at least a portion of the pricing information. At least a portion of the pricing information is provided such that at least one of (a) a program executing on a computing device receives the pricing information as input or (b) a user computing device receives the at least a portion of the pricing information and provides a representation of the at least a portion of the pricing information via an interactive user interface provided via a display of the user computing device.

According to another aspect, an apparatus for pricing callable instruments is provided. In an example embodiment, the apparatus comprises processing circuitry (e.g., one or more processors, solver circuitry, and/or DNN circuitry). In an example embodiment, the processing circuitry is configured to define a set of dates comprising a plurality of time-ordered dates, the set of dates comprising a particular exercise date of the callable instrument; determine a plurality of paths corresponding to a value of an underlying entity of the callable instrument, each path corresponding to the set of dates; and train a deep neural network (DNN) of a backward DNN with value reset solver until a convergence requirement is satisfied. In an example embodiment, the processing circuitry is configured to train the DNN by, for each path of the plurality of paths, using the backward DNN with value reset solver, determining a callable instrument value for each of the plurality of dates of the set of dates, wherein for each path (a) a final value, corresponding to a final date of the set of dates, is determined, (b) intermediate values, corresponding to the dates of the set of dates between an initial date and the final date of the set of dates, are determined in reverse time order, and (c) an initial value, corresponding to the initial date of the set of dates, is determined; defining a set of initial values comprising the initial value determined for each path and determining one or more statistical measures of spread based on the set of initial values; and modifying one or more parameters of the DNN based on the one or more statistical measures of spread. While training backward DNN with value reset solver is configured to, when determining the intermediate values, when the intermediate value corresponding to the particular exercise date is determined, an expected value corresponding to the particular exercise date is determined and evaluated based on one or more criteria; responsive to the expected value corresponding to the particular exercise date satisfying the one or more criteria, the intermediate value corresponding to the particular exercise date is set to a reset value; and responsive to the expected value corresponding to the particular exercise date not satisfying the one or more criteria, not modifying the intermediate value corresponding to the particular exercise date. The processing circuitry is configured to after the convergence requirement is satisfied, determine pricing information for the callable instrument using the backward DNN with value reset solver; and provide at least a portion of the pricing information. The at least a portion of the pricing information is provided such that at least one of (a) a program executing on a computing device receives the pricing information as input or (b) a user computing device receives the at least a portion of the pricing information and provides a representation of the at least a portion of the pricing information via an interactive user interface provided via a display of the user computing device.

The foregoing brief summary is provided merely for purposes of summarizing some example embodiments illustrating some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized herein, some of which will be described in further detail below.

### BRIEF DESCRIPTION OF THE FIGURES

Having described certain example embodiments of the present disclosure in general terms above, reference will now be made to the accompanying drawings, which are not necessarily drawn to scale. Some embodiments may include fewer or more components than those shown in the figures.

FIG. 1 is a block diagram showing an example architecture of one embodiment described herein.

FIG. 2 is a block diagram of a model computing device that may be specifically configured in accordance with an example embodiment described herein.

FIG. 3 is a block diagram of a user computing entity that may be specifically configured in accordance with an example embodiment described herein.

FIG. 4 is a block diagram showing an example architecture of a deep backward stochastic differential equation (BSDE) backward solver for determining callable instruments values, in accordance with an example embodiment described herein.

FIG. 5 is a flowchart illustrating operations performed, such as by the model computing device of FIG. 2 to provide callable instruments values, in accordance with an example embodiment described herein.

FIG. 6 illustrates an example IUI that may be used to cause the generation of a callable instruments values request, in an example embodiment described herein.

FIG. 7 illustrates an example IUI providing callable instruments values, according to an example embodiment described herein.

FIG. 8 is a flowchart illustrating operations performed, such as by the model computing device of FIG. 2 to reset a callable instrument value corresponding to one or more possible exercise dates and/or call dates, in accordance with an example embodiment described herein.

### DETAILED DESCRIPTION

Some embodiments of the present disclosure will now be described more fully hereinafter with reference to the accompanying figures, in which some, but not all embodiments of the disclosures are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

Where the specification states that a particular component or feature “may,” “can,” “could,” “should,” “would,” “preferably,” “possibly,” “typically,” “optionally,” “for example,” “often,” “exemplary,” or “might” (or other such language) be included or have a characteristic, that particular component or feature is not required to be included or to have the characteristic. Such terminology is intended to convey that the particular component or feature is included in some embodiments while excluded in others, or has the characteristic in some embodiments while lacking the characteristic in others.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessary to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

### Overview

Various embodiments provide methods, systems, apparatuses, and/or computer program products for the efficient determination of the value of callable instruments at one or more points in time. For example, various embodiments provide methods, systems, apparatuses, and/or computer program products for determining the value of callable instruments, possibly for multiple callable instruments, at a plurality of points in time (e.g., including possible exercise dates and/or call dates of the callable instruments). Various embodiments are configured to determine and provide the value of callable instruments for one or more callable instruments at one or more points in time in real time or near real time with respect to receiving a corresponding request. Various embodiments provide an interactive user interface (IUI) through which a user may cause a request for value determination to be provided and through which a user may be provided a graphical and/or tabular representation of callable instrument values for one or more callable instruments at one or more points in time.

In various embodiments, the value of the callable instrument(s) is determined using a backward deep neural network (DNN) with value reset solver. In various embodiments, the problem for determining the value of the callable instrument(s) may be posed as a partial differential equation (PDE) and/or an equivalent backward stochastic differential equation (BSDE). In various embodiments, the value of the callable instrument(s) depends on one or more underlying entities such as one or more stocks, indices (e.g., equity indices such as the SPDR S&P 500 trust (SPY) or NASDAQ 100 Trust (QQQ), for example),), and/or the like. The PDE and/or BSDE may be configured to describe the evolution of the value of the callable instrument with respect to the underlying entity. In various embodiments, the backward DNN with value reset solver, through machine learning, is trained to describe the sensitivity of the value of the callable instrument to changes in the corresponding underlying entity. For example, the backward DNN with value reset solver may use the sensitivity of the value of the callable instrument to changes in the corresponding underlying entity at various points in time to determine the value of the callable instrument at various points in time. In various embodiments, the DNN of the backward DNN with value reset solver comprises a plurality of sub-networks, with each sub-network corresponding to a defined set of times {tᵢ|i=0, 1, . . . , N} (e.g., including at least one of the multiple exercise dates tₖ). Each of the sub-networks are trained simultaneously such that the value of callable instrument at multiple points in time are determined through one training of the DNN of the backward DNN with value reset solver.

In various embodiments, a training iteration of the DNN of the backward DNN with value reset solver comprises determining a final value of the callable instrument at a final time in the defined set of times (e.g., t_{N}) and projecting the value of the callable instrument backward (possibly based on an underlying entity), through one or more intermediate values corresponding to one or more intermediate times of defined set of times, back to an initial value of the callable instrument corresponding to an initial time (e.g., t₀) of the defines set of times. This backward projection is performed along a plurality of paths (e.g., Monte Carlo paths) and a set of initial values of the callable instrument are determined therefrom. A statistical measure of spread (e.g., variance, standard deviation, and/or the like) for the set of initial values is determined and the weights and/or parameters of the DNN of the backward DNN with value reset solver are modified to reduce the statistical measure of spread for the set of initial values determined on the next training iteration of backward projection for the plurality of paths. Once the DNN of the backward DNN with value reset solver satisfies a convergence requirement (e.g., the statistical measure of spread is sufficiently small and/or the number of training iterations has reached a particular number) the resulting values of the callable instrument at the various points in time are provided (e.g., for display to a user via a user computing device, stored in memory for later use, and/or the like). This backward projection of the value of the callable instrument provides the basis of the backward DNN portion of the name backward DNN with value reset solver. In various embodiments, the DNN of the backward DNN with value reset solver comprises a feedforward DNN. For example, the information within the DNN of the backward DNN with value reset solver moves from the input nodes, through the hidden nodes, and out to the output nodes without forming any cycles or loops within the network.

In various embodiments, the backward DNN with value reset solver is configured to evaluate an expected value of callable instrument with respect to one or more criteria. In various embodiments, if the expected value of the callable instrument satisfies one or more criteria, the value of the callable instrument may be reset. In various embodiments, resetting the value of the callable instrument at a possible exercise date and/or call date comprises setting the value of the callable instrument to a call value of the callable instrument at the possible exercise date and/or call date. In an example embodiment, the evaluating the one or more criteria includes comparing the expected value of the callable instrument at the possible exercise date and/or call date to the call value of the callable instrument at the possible exercise date and/or call date. In such an embodiment, the one or more criteria are satisfied when the expected value of the callable instrument at the possible exercise date and/or call date is less than the call value of the callable instrument at the possible exercise date and/or call date. In various embodiments, the expected value of the callable instrument is determined based on a least square regression of the value of the callable instrument with respect to one or more underlying entities of the callable instrument. The resetting of the value of the callable instrument provides the backward DNN with value reset solver with the second portion of its name.

The backward DNN with value reset solver allows for efficient determination of values of callable instruments at various points in time. Moreover, the backward DNN with value reset solver directly estimates the sensitivity of the value of the callable instrument to the underlying entity without introducing additional model assumptions. These features contrast with traditional means for determining values of a callable instrument. For example, traditional means for determining values of a callable instrument are computationally expensive as they require use of a Monte Carlo method using a very large number of Monte Carlo paths. For example, such Monte Carlo methods require more than a factor of ten more paths than the backward DNN with value reset solver. Additionally, such traditional methods require additional modelling of the sensitivity of the value of the callable instrument to the underlying entity, which then introduces additional model assumptions.

Accordingly, the present disclosure sets forth systems, methods, apparatuses, and computer program products that accurately and computationally efficiently determine and provide the value of one or more callable instruments at various points of time (e.g., at one or more possible exercise dates and/or call dates). There are many advantages of these and other embodiments described herein. For instance, the computational efficiency of various embodiments of the backward DNN with value reset solver described herein allows for the providing of the value of one or more callable instruments at various points of time and/or an optimal calling strategy for one or more callable instruments in real time or near real time with respect to the receipt of a request for such while still providing accurate results and/or predictions. Thus, embodiments of the backward DNN with value reset solver may be used to inform decisions on relatively short time frames. In addition, since the backward DNN with value reset solver directly determines the sensitivity of the value of the callable instrument to the underlying entity, fewer model assumptions are used to determine the value of the callable instrument at various points of time.

Although a high level explanation of the operations of example embodiments has been provided above, specific details regarding the configuration of such example embodiments are provided below.

### System Architecture

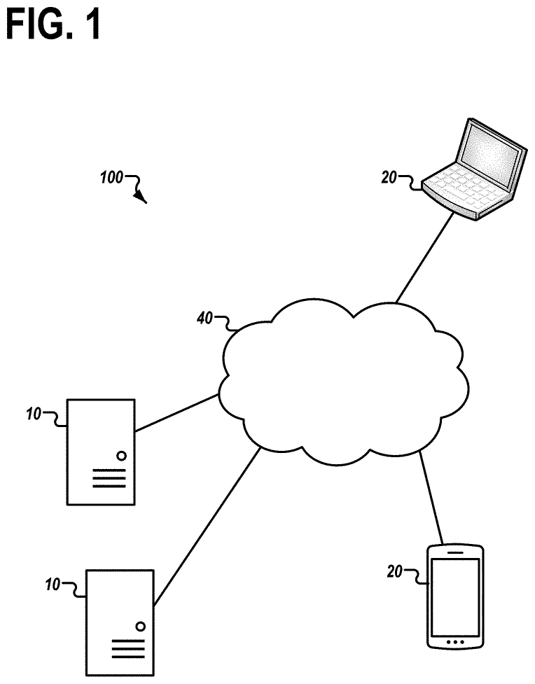

Example embodiments described herein may be implemented using any of a variety of computing devices or servers. To this end, FIG. 1 illustrates an example environment 100 within which embodiments of the present disclosure may operate to generate and provide callable instruments values and/or IUIs configured for providing callable instruments values. As illustrated, the example embodiment 100 may include one or more model computing devices 10 and one or more user computing devices 20. The one or more model computing devices 10 and/or one or more user computing devices 20 may be in electronic communication with, for example, one another over the same or different wireless or wired networks 40. For example, a user computing device 20 may provide (e.g., transmit, submit, and/or the like) a request for callable instruments values to a model computing device 10 via one or more wireless or wired networks 40. For example, a model computing device 10 may provide (e.g., transmit) callable instruments values to a user computing entity 20 via one or more wireless or wired networks 40.

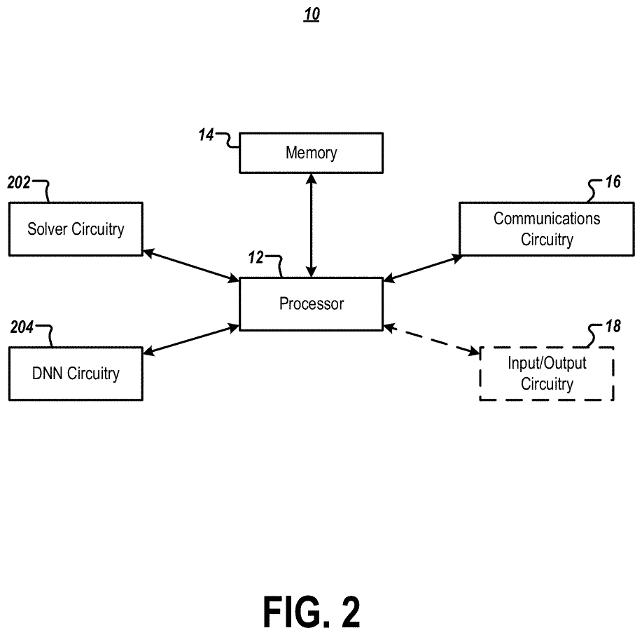

The one or more model computing devices 10 may be embodied as one or more servers, such as that described below in connection with FIG. 2. The one or more model computing devices 10 may further be implemented as local servers, remote servers, cloud-based servers (e.g., cloud utilities), or any combination thereof. The one or more model computing devices 10 may receive, process, generate, and transmit data, signals, and electronic information to facilitate the operations of determining and providing callable instruments values. In various embodiments, a model computing device 10 may store and/or be in communication with one or more databases. In an example embodiment, the one or more databases may be embodied as one or more data storage devices, such as a Network Attached Storage (NAS) device or devices, or as one or more separate databases or servers. The one or more databases may store information accessed by the model computing device 10 to facilitate the operations of determining and providing callable instruments values. For example, the one or more databases may store control signals, device characteristics, and access credentials for one or more of the user computing devices 20.

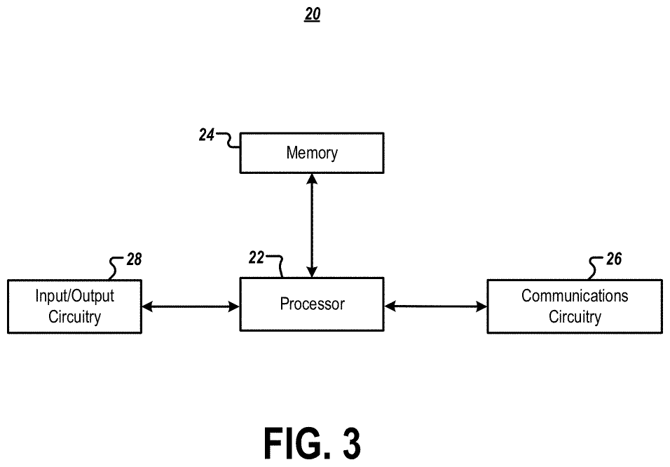

The one or more user computing devices 20 may be embodied by any computing devices known in the art, such as those described below in connection with FIG. 3. The model computing device 10 may receive information from, and transmit information to, the one or more user computing devices 20. For example, the model computing device 10 may receive a request for callable instruments values generated and provided by a user computing device 20. For example, the model computing device may provide callable instruments values such that a user computing device 20 receives the callable instruments values. It will be understood that in some embodiments, the one or more user computing devices 20 need not themselves be independent devices but may be peripheral devices communicatively coupled to other computing devices.

### Exemplary Computing Devices

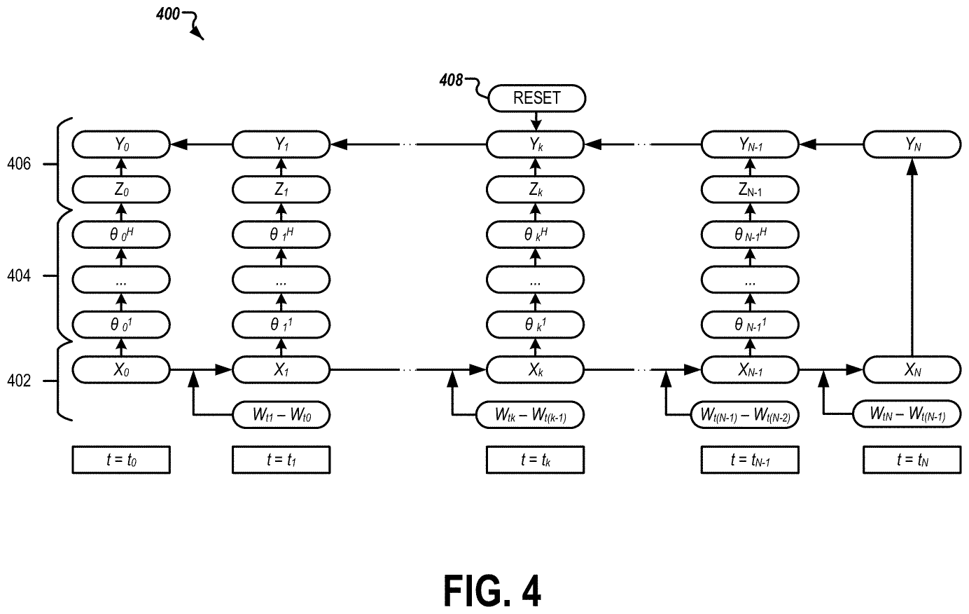

The model computing device 10 described with reference to FIG. 1 may be embodied by one or more computing devices or servers, such as the example model computing device 10 shown in FIG. 2. As illustrated in FIG. 2, the model computing device 10 may include processing circuitry 12, memory 14, communications circuitry 16, input-output circuitry 18, solver circuitry 202, and deep neural network (DNN) circuitry 204, each of which will be described in greater detail below. In some embodiments, the model computing device 10 may further comprise a bus (not expressly shown in FIG. 2) for passing information between various components of the model computing device. The model computing device 10 may be configured to execute various operations described above in connection with FIG. 1 and below in connection with FIGS. 4, 5, and 8.

In some embodiments, the processor 12 (and/or co-processor or any other processing circuitry assisting or otherwise associated with the processor) may be in communication with the memory 14 via a bus for passing information among components of the apparatus. The processor 12 may be embodied in a number of different ways and may, for example, include one or more processing devices configured to perform independently. Additionally or alternatively, the processor may include one or more processors configured in tandem via a bus to enable independent execution of software instructions, pipelining, and/or multithreading. The use of the terms “processor” or “processing circuitry” may be understood to include a single core processor, a multi-core processor, multiple processors of the model computing device 10, remote or “cloud” processors, or any combination thereof.

In an example embodiment, the processor 12 may be configured to execute software instructions stored in the memory 14 or otherwise accessible to the processor. Alternatively or additionally, the processor 12 may be configured to execute hard-coded functionality. As such, whether configured by hardware or software methods, or by a combination of hardware with software, the processor 12 may represent an entity (e.g., physically embodied in circuitry) capable of performing operations according to an embodiment of the present invention while configured accordingly. Alternatively, as another example, when the processor 12 is embodied as an executor of software instructions, the software instructions may specifically configure the processor 12 to perform the algorithms and/or operations described herein when the software instructions are executed.

Memory 14 is non-transitory and may include, for example, one or more volatile and/or non-volatile memories. In other words, for example, the memory 14 may be an electronic storage device (e.g., a computer readable storage medium). The memory 14 may be configured to store information, data, content, applications, software instructions, or the like, for enabling the apparatus to carry out various functions in accordance with example embodiments contemplated herein.

The communications circuitry 16 may be any means such as a device or circuitry embodied in either hardware or a combination of hardware and software that is configured to receive and/or transmit data from/to a network and/or any other device, circuitry, or module in communication with the model computing device 10. In this regard, the communications circuitry 16 may include, for example, a network interface for enabling communications with a wired or wireless communication network. For example, the communications circuitry 16 may include one or more network interface cards, antennas, buses, switches, routers, modems, and supporting hardware and/or software, or any other device suitable for enabling communications via a network 40. Additionally or alternatively, the communication interface 16 may include the circuitry for causing transmission of such signals to a network or to handle receipt of signals received from a network.

In some embodiments, the model computing device 10 may include input/output circuitry 18 in communication configured to provide output to a user and, in some embodiments, to receive an indication of user input. The input/output circuitry 18 may comprise a user interface, such as a display, and may further comprise the components that govern use of the user interface, such as a web browser, mobile application, dedicated client device, or the like. In some embodiments, the input/output circuitry 18 may additionally or alternatively include a keyboard, a mouse, a touch screen, touch areas, soft keys, a microphone, a speaker, and/or other input/output mechanisms. The input/output circuitry 18 may utilize the processor 12 to control one or more functions of one or more of these user interface elements through software instructions (e.g., application software and/or system software, such as firmware) stored on a memory (e.g., memory 14) accessible to the processor 12.

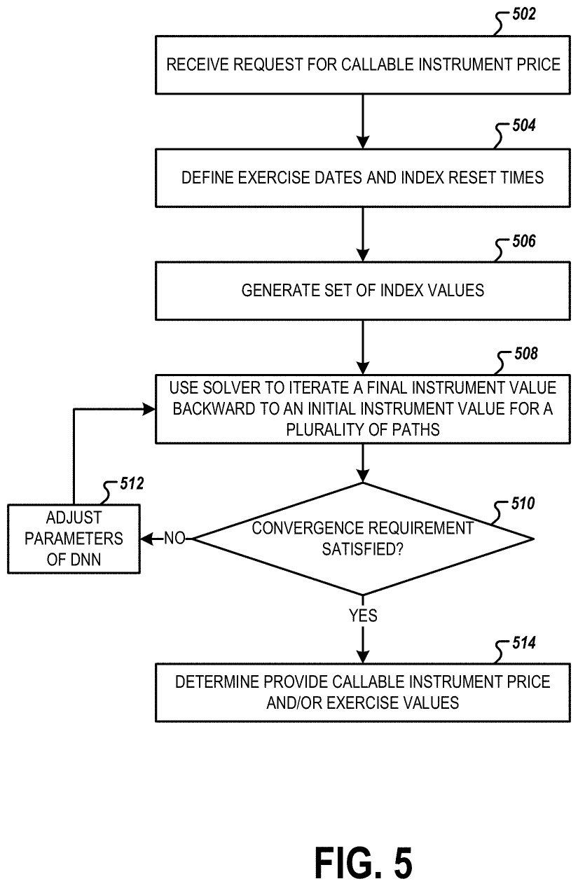

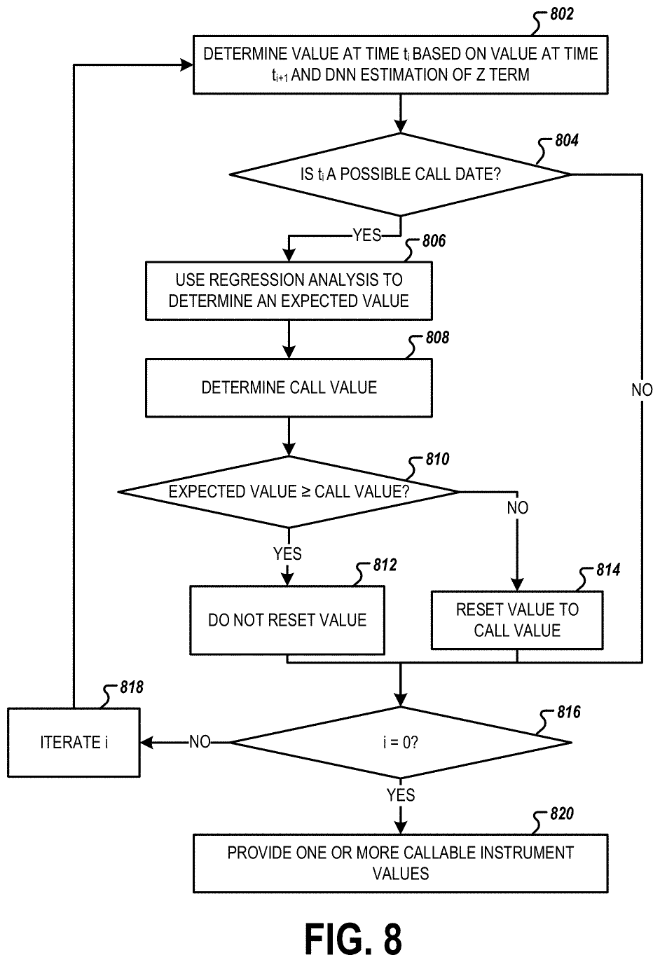

In addition, the model computing device 10 further comprises solver circuitry 202, which includes hardware components designed for acting as a deep learning-based BSDE solver. The solver circuitry 202 may utilize processor 12, memory 14, or any other hardware component included in the model computing device 10 to perform these operations, as described in connection with FIGS. 5 and 8 below. The solver circuitry 202 may further utilize communications circuitry 16 to receive callable instruments values requests and/or provide callable instruments values (e.g., in response to a request therefor), or may otherwise utilize processor 12 and/or memory 14 to access information/data and/or executable instructions (e.g., software) used to determine callable instruments values and/or to store determined callable instruments values, and/or the like. In an example embodiment, the functionality described herein as being performed by the solver circuitry 202 is performed through the execution executable instructions by the processor 12. In an example embodiment, the solver circuitry 202 comprises one or more graphical processing units (GPUs).

In addition, the model computing device 10 further comprises DNN circuitry 204, which includes hardware components designed for training and/or operating a DNN. The DNN circuitry 204 may utilize processor 12, memory 14, or any other hardware component included in the model computing device 10 to perform these operations, as described in connection with FIGS. 5 and 8 below. The DNN circuitry 204 may further utilize processor 12 and/or memory 14 to access information/data and/or executable instructions for determining, providing, and/or storing one or more option value gradients, adjust network weights through the minimization of a loss function, and/or the like. In an example embodiment, the functionality described herein as being performed by the DNN circuitry 202 is performed through the execution executable instructions by the processor 12. In an example embodiment, the DNN circuitry 204 comprises one or more graphical processing units (GPUs).

Although these components 12-18 and 202-204 may in part be described using functional language, it will be understood that the particular implementations necessarily include the use of particular hardware. It should also be understood that certain of these components 12-18 and 202-204 may include similar or common hardware. For example, the solver circuitry 202 and DNN circuitry 204 may each at times leverage use of the processor 12 or memory 14, but duplicate hardware is not required to facilitate operation of these distinct components of the model computing device 10 (although duplicated hardware components may be used in some embodiments, such as those in which enhanced parallelism may be desired). The use of the term “circuitry” as used herein with respect to components of the model computing device 10 therefore shall be interpreted as including the particular hardware configured to perform the functions associated with the particular circuitry described herein. Of course, while the term “circuitry” should be understood broadly to include hardware, in some embodiments, the term “circuitry” may refer also to software instructions that configure the hardware components of the model computing device 10 to perform their various functions.

To this end, each of the communications circuitry 16, input/output circuitry 18, solver circuitry 202, and DNN circuitry 204 may include one or more dedicated processors, specially configured field programmable gate arrays (FPGA), and/or application specific interface circuit (ASIC) to perform its corresponding functions, these components may additionally or alternatively be implemented using a processor (e.g., processor 12) executing software stored in a memory (e.g., memory 14). In this fashion, the communications circuitry 16, input/output circuitry 18, solver circuitry 202, and DNN circuitry 204 are therefore implemented using special-purpose components implemented purely via hardware design or may utilize hardware components of the model computing device 10 that execute computer software designed to facilitate performance of the functions of the communications circuitry 16, input/output circuitry 18, solver circuitry 202, and DNN circuitry 204.

The user computing device 20 described with reference to FIG. 1 may be embodied by one or more computing devices, personal computers, desktop computers, client devices (e.g., of the model computing device 10), and/or mobile devices, such as the example user computing device 20 shown in FIG. 3. The illustrated example user computing device 20 includes processing circuitry and/or processor 22, memory 24, communications circuitry 26, and input-output circuitry 28, each of which is configured to be similar to the similarly named components described above in connection with FIG. 2. In various embodiments, the processor 22, memory 24, and input-output circuitry 28 are configured to provide an IUI configured for user interaction (e.g., via the input-output circuitry 28). For example, the IUI may be configured to receive user input initiating a callable instruments values request and/or to provide callable instruments values.

In some embodiments, various components of the model computing device 10 and/or user computing device 20 may be hosted remotely (e.g., by one or more cloud servers) and thus need not physically reside on the corresponding computing device 10, 20. Thus, some or all of the functionality described herein may be provided by third party circuitry. For example, a given computing device 10, 20 may access one or more third party circuitries via any sort of networked connection that facilitates transmission of data and electronic information between the computing device 10, 20 and the third party circuitries. In turn, that computing device 10, 20 may be in remote communication with one or more of the other components describe above as comprising the computing device 10, 20.

As will be appreciated based on this disclosure, example embodiments contemplated herein may be implemented by a model computing device 10 and/or user computing device 20. Furthermore, embodiments may take the form of a computer program product on at least one non-transitory computer-readable storage medium (e.g., memory 14, 24) storing software instructions. Any suitable non-transitory computer-readable storage medium may be utilized, some examples of which are non-transitory hard disks, CD-ROMs, flash memory, optical storage devices, and magnetic storage devices. It should be appreciated, with respect to certain model computing devices 10 as described in FIG. 2 or user computing devices 20 as described in FIG. 3, that loading the software instructions onto a computer or apparatus produces a special-purpose machine comprising the means for implementing various functions described herein.

Having described specific components of example model computing devices 10 and user computing devices 20, example embodiments are described below in connection with a series of flowcharts.

### Example Backward DNN with Value Reset Solver

In various embodiments, a backward DNN with value reset solver is used to determine the value of one or more callable instruments at various points in time (e.g., exercise dates). In various embodiments, the one or more callable instruments may be priced, and/or the value may evolve based on one or more underlying entities such as one or more indices, stocks, foreign exchange rate, and/or other instruments. In various embodiments, the index is an equity index.

In various embodiments, the backward DNN with value reset solver is used to solve for the value of one or more callable instrument at various points time {tᵢ|i=0 . . . N}. In various embodiments, the points of time {tᵢ} include one or more possible exercise dates {tₖ}⊆{tᵢ} for the callable instrument. In various embodiments, the callable instrument reaches maturity at maturity time T. In various embodiments, the maturity time Tis one of the points in time at which the value of the callable instrument is determined (e.g., T=t_{N}∈{tᵢ}).

In various embodiments, the problem to be solved is reformulated in terms of backward stochastic differential equations (BSDEs). In various embodiments, these equations are non-anticipating terminal value problems for stochastic differential equations (SDEs) of the form

−dYₜ=ƒ(t,Yₜ,Zₜ)dt−ZₜdWₜ

Y_{T}=ξ (Equation 1)

where Yₜ is the value of the callable instrument at time t, ƒ is the drift term, Zₜ is the Z term and corresponds to the hedging portfolio corresponding to the callable instrument, Wₜ is a standard d-dimensional Brownian motion defined on a complete probability space, ξ is the terminal condition (e.g., the value of the callable instrument at the maturity time T). In various embodiments, the terminal condition ξ (measurable with respect to filtration generated up to time T by the Brownian motion) is twice-integrable. In various embodiments, the Brownian motion, terminal condition ξ, and the drift function ƒ are given, known, and/or able to be determined based on prior information. For example, Brownian motion, terminal condition ξ, and/or the drift function ƒ may be used to define each path of a plurality of paths. In various embodiments, the value of the callable instrument Yₜ corresponds to the value process and the Z term Zₜ may be used to determine an optimal control corresponding to a portfolio optimization problem. For example, the Z term Zₜ may correspond to an equivalent partial differential equation (PDE) gradient.

In various embodiments, the question at hand may be formulated as forward-backward stochastic differential equations (FBSDEs) of the form

dXₜ=μ(t,Xₜ)dt+σ(t,Xₜ)dWₜ

X₀=x

−dYₜ=ƒ(t,Xₜ,Yₜ,Zₜ)dt−ZₜdWₜ

Y_{T}=g(X_{T}) (Equation 2)

where Xₜ is an underlying entity (e.g., index, stock, and/or the like) value at time t, μ is the drift term of the underlying entity, σ is a volatility measure, x is the underlying entity value at time t=0, and g is a function describing the relationship between the value of the callable instrument at the maturity time Y_{T} and the value of the underlying entity value at the maturity time X_{T}. In general, these are referenced to as forward backward stochastic differential equations because the initial value of the underlying entity X (e.g., X₀=x) is given and thus X is propagated forward in time to determine the underlying entity value at time t Xₜ, while the terminal value of Y (e.g., the value of Y at the maturity time T) is given and thus Y is propagated backward in time to determine its initial value.

In various embodiments, the volatility measure is specified as σₜ(t, Xₜ)=λ(t)φ(Xₜ), where λ(t) is a bounded row-vector of deterministic functions and φ: [symbol] → [symbol] is a time-homogenous local volatility function. In various embodiments, the local volatility function may be a lognormal model (e.g., φ(x)=x), a constant elasticity of variance (CEV) model (e.g., φ(x)=x^{p}, where 0<p<1), a limited CEV (LCEV) model (e.g., φ(x)=min(ε^{p-1},x^{p-1}), where 0<p<1 and ε>0), a displaced lognormal model (e.g., φ(x)=bx+a, where b>0 and a≠0), and/or the like.

In various embodiments, Xₜ may be the value of a stock and/or other index at time t. From Equations 2.2, it follows that

dXₜ=(r−q)Xₜdt+σXₜdWₜ (Equation 3)

where r is a discount rate or interest rate (assumed here to be constant) of the underlying entity, q is the dividend of the stock/underlying entity (assumed here to be constant), and σ is the volatility of the underlying entity (assumed here to be constant).

In an example embodiment, a portfolio Π according to Π=Y−ΔX, where Δ is selected so that the derivative of the value of the portfolio H is deterministic. In an example embodiment we have

$$d \prod = dY - Δ dX - q Δ Xdt = ( \frac{\partial Y}{\partial t} + \frac{1}{2} {σ}^{2} {X}^{2} \frac{{\partial }^{2} Y}{\partial {X}^{2}} ) dt + \frac{\partial Y}{\partial X} dX - Δ dX - q Δ Xdt ,$$

where the term qΔXdt arises from the stock X paying dividends which decreases the value of the portfolio Π by the amount of the dividend. In an example embodiment, Δ is selected such that

$$Δ = \frac{\partial Y}{\partial X}$$

and such that

$$d \prod = ( \frac{\partial Y}{\partial t} + \frac{1}{2} {σ}^{2} {X}^{2} \frac{{\partial }^{2} Y}{\partial {X}^{2}} ) d t - q Δ Xdt .$$

Since the value of the portfolio Π is deterministic and risk free, the derivative of the value of the portfolio is dΠ=rΠdt=r(Y−ΔX)dt. This leads to the following Back Scholes

$$PDE \frac{\partial Y}{\partial t} + \frac{1}{2} {σ}^{2} {X}^{2} \frac{{\partial }^{2} Y}{\partial {X}^{2}} + ( r - q ) X \frac{\partial Y}{\partial X} - rY = 0.$$

By applying Itô's Lemma, we have

$$dY = ( \frac{\partial Y}{\partial t} + \frac{1}{2} {σ}^{2} {X}^{2} \frac{{\partial }^{2} Y}{\partial {X}^{2}} ) d t + \frac{\partial Y}{\partial X} d X = ( rY - ( r - q ) X \frac{\partial Y}{\partial X} ) dt + \frac{\partial Y}{\partial X} ( ( r - q ) X d t + σ X d W ) = rYdt + σ X \frac{\partial Y}{\partial X} dW \\ or \\ - dY = - rYdt - σ X \frac{\partial Y}{\partial X} dW . \qquad ( Equation 4 )$$

In comparing Equation 4 and Equation 2, we see that

$$f = - rY and Z = σ X \frac{\partial Y}{\partial X} .$$

As should be understood, this formulation may be extended to high dimensional derivative pricing where, for example, Y=Y(X¹, X², . . . , X^{d}), and we have

$$d {X}_{t}^{i} = {μ}^{i} ( t , {X}_{t}^{i} ) d t + {σ}^{i} ( t , {X}_{t}^{i} ) d {W}_{t}^{i} \\ {X}_{0}^{i} = {x}^{i} - {dY}_{t} = - {rY}_{t} dt - \sum {σ}^{i} {X}^{i} \frac{\partial {Y}_{t}}{\partial {X}_{t}^{i}} d {W}_{t}^{i} {Y}_{T} = g ( {X}_{T}^{1} , {X}_{T}^{2} , … , {X}_{T}^{d} ) \\ cov ( {dW}_{t}^{i} , {dW}_{t}^{j} ) = {ρ}^{i j} dt with \vert {ρ}^{i j} \vert < 1 \qquad ( Equation 5 )$$

An example of a callable instrument is a Bermudan option. In general, a Bermudan option is a type of exotic option that can only be exercised on predetermined dates {tₖ}. A Bermudan option is exercisable at the date of expiration and on certain specified dates {tₖ} that occur between the purchase date t₀ and the date of expiration t_{N}. A Bermudan option is a combination of American and European options. The payoff function of a Bermudan option is given by

payoff(T)=payoff(t_{N})=max(Σᵢ₌₁^{d}ωᵢXⁱ(T)−K,0) (Equation 6)

where K is the strike of the option and the weights ωᵢ are given constants. When an exercise event happens, the option expires and the holder will receive its intrinsic value.

Another example of a callable instrument is a callable yield note (CYN). A CYN is a yield enhancement product whose performance is capped by a coupon that is guaranteed by the issuer. As the name implies, the issuer, at its discretion, can call the product, usually on predefined observation dates. The underlying entities are generally composed of serval stocks or stock indices or other indices, thus making it a product based on a worst-of function. The call notice dates for a CYN (e.g., possible exercise dates {tₖ}) are usually identical to the coupon record dates and we denote them herein as tₖ, k=1, 2, . . . , n, with tₙ=t_{N}=T, where T is the maturity date and/or expiry date. The coupon payments are subject to a barrier condition and the knock-in barrier is observed at expiry. The coupon payment per unit of notational is

c(tᵢ)=rᵢΘ(p(tᵢ)−Bᵢ) for i=1,2, . . . , n−1

c(tₙ)=rₙΘ(p(T)−B_{N})−Θ(B−p(T))max(K−p(T),0) (Equation 7)

where rᵢ is the contingent coupon with coupon barrier Bᵢ on the ith coupon day, B is the knock-in barrier at expiry, K is the knock-in put strike, p(t) is the relevant performance since trade inception

$$( e . g . , p ( t ) = {min}_{j ∈ \{ 1 , 2 , … , d \}} [ \frac{{X}^{j} ( t )}{{X}^{j} ( 0 )} ]$$

and Θ is the Heaviside function, where

$$Θ ( x ) = \{ \begin{matrix}1 for x \geq 1 \\ 0 otherwise\end{matrix} .$$

Upon redemption (e.g., at the scheduled maturity/expiration date T or early issuer call at time tₖ) the principal notational is returned to the holder. That is

payoff(T)=notational+c(t_{N})

call value(tᵢ)=notational for i=1,2, . . . , n−1. (Equation 8)

Pricing and/or determining optimal calling strategies for exotic options and/or options having early exercise options, such as Bermudan options, is generally difficult. In particular, at any future time of an exercise date, according to the dynamic programming principle for optimality, the continuation value of the option must be known as well. Given the numerical scheme for pricing, forward estimation of the continuation value is computationally difficult and expensive. However, various embodiments use a backward solution method such that the determination of the continuation value is automatically determined as the value of the callable instrument (e.g., Yₜ) is determined as the value of the callable instrument is iterated backwards from the maturity time T=t_{N}=tₙ to the initial time t₀.

For example, in various embodiments, the value of the callable instrument is propagated backward in time and the call/put and coupon events are applied. In general, we have Yᵢ=Yᵢ₊₁+ƒ(tᵢ, Xᵢ, Zᵢ(θᵢ)hᵢ−Zᵢ(θᵢ)dWᵢ, where θ^{(j)}={θ₀^{(j)}, θ₁^{(j)}, . . . , θ_{(N-1)}^{(j)}} are parameters for a neural network at each time step for a jth path, hᵢ is the ith timestep such that hᵢ=tᵢ₊₁−tᵢ, and dWᵢ=Wₜ_{ᵢ₊₁}−Wₜ_{ᵢ}. As we propagate backward in time from tᵢ₊₁ to tᵢ, the value of the callable instrument at time tᵢ₊₁ (e.g., Yₜ_{ᵢ₊₁}) is known while the value of the callable instrument at time tᵢ (e.g., Yₜ_{ᵢ}) is determined. In an example embodiment, a first order Taylor expansion is used to approximate the value of the callable instrument at time tᵢ (e.g., Yₜ_{ᵢ}). In an example embodiment, a higher order Taylor expansion or other approximation is used to approximate the value of the callable instrument at time tᵢ (e.g., Yₜ_{ᵢ}). In an example embodiment, a numerical method is used to determine the value of the callable instrument at time tᵢ (e.g., Yₜ_{ᵢ}). In an example, embodiment, where a first order Taylor expansion is used to approximate the value of the callable instrument at time tᵢ (e.g., Yₜ_{ᵢ}),

$${Y}_{i} \approx {Y}_{i + 1} ( f ( {t}_{i} , {X}_{i} , {Y}_{i + 1} , {Z}_{i} ( {θ}_{i} ) ) - \frac{\partial f}{\partial Y} ( {t}_{i} , {X}_{i} , {Y}_{i + 1} , {Z}_{i} ( {θ}_{i} ) ) ( {Y}_{i + 1} - {Y}_{i} ) ) {h}_{i} - {Z}_{i} ( {θ}_{i} ) d {W}_{i} ,$$

which leads to

$${Y}_{i} \approx {Y}_{i + 1} + \frac{1}{1 - \frac{\partial f}{\partial Y} ( {t}_{i} , {X}_{i} , {Y}_{i + 1} , {Z}_{i} ( {θ}_{i} ) ) {h}_{i}} ( f ( {t}_{i} , {X}_{i} , {Y}_{i + 1} , {Z}_{i} ( {θ}_{i} ) ) {h}_{i} - {Z}_{i} ( {θ}_{i} ) d {W}_{i} ) .$$

In various embodiments, based on Equation 4, the first order Taylor expansion approximation provides the exact solution. For example, applying Equation 4, we have

$${Y}_{i} = \frac{{Y}_{i + 1} - {Z}_{i} ( {θ}_{i} ) d {W}_{i}}{1 + {rh}_{i}} . \qquad ( Equation 9 )$$

Starting from t_{N}=T, the value of the callable instrument is propagated backward in time to t₀=0 to obtain the estimated initial value Y₀^{(j)}(θ^{(j)}) for each sampled path j, where θ^{(j)}={θ₀^{(j)}, θ₁^{(j)}, . . . , θ_{(N-1)}^{(j)}} are the parameters for a neural network at each time step for the jth path. In various embodiments, the paths are determined using a Monte Carlo method, as described in more detail elsewhere herein. In general, the parameters for the neural network are tuned such that the estimated initial value Y₀^{(j)}(θ^{(j)}) of each of a plurality of paths converge. For example, in an example embodiment, a loss function may be defined such that L=Mean_{all paths}(Y₀^{(j)}(θ^{(j)})−Mean_{all paths}(Y₀^{(j)}(θ^{(j)})))². In various embodiments, a deep neural network (DNN) may be trained based on the loss function L. For example, the variance or other statistical measure of spread of the estimated initial values Y₀^{(j)}(θ^{(j)}) of a plurality of paths may be minimized to train the DNN. In an example embodiment, an optimization procedure may be used to minimize the variance or other statistical measure of spread of the estimated values Y₀^{(j)}(θ^{(j)}) of a plurality of paths. In an example embodiment, the initial price [symbol] (e.g., at t₀), is the mean initial value of the plurality of paths, such that [symbol] =Mean_{all paths}(Y₀^{(j)}(\tilde{θ}^{(j)}), where \tilde{θ}^{(j)}=arg min_{θ}L.

In various embodiments, the callable instrument value is reset at one or more times during the propagation of the callable instrument value backward from the maturity and/or expiry date T=t_{N} to the initial date t₀=0. In various embodiments, the one or more resets of the callable instrument value is performed using a least square regression. In an example embodiment, the reset of the callable instrument value is performed at one or more of the possible exercise dates and/or call dates tₖ∈{tᵢ}. For example, a regression equation such as Yₖ=a+bXₖ+cXₖ²+ν, where ν is white noise and ν˜N(0,η²). For example, the expected callable instrument value may be estimated as εYₖ=a+bXₖ+cXₖ², omitting the white noise term. The least square regression may be performed over each of the paths (e.g., at each possible exercise date and/or call date tₖ ∈{tₖ|k=0, 1, . . . , n}⊆{tᵢ} having a positive call value. An example call value for a Bermudan option is provided by Equation 8. Various basis functions may be used to perform the least square regression (e.g., weighted Laguerre polynomials, and/or the like). The value of the callable instrument, in the example of the Bermudan option, at the possible exercise date and/or call date tₖ (e.g., Yₖ) is then

$${Y}_{k} = \{ \begin{matrix}{Y}_{k} if ε {Y}_{k} \geq c a l l v a l u e ( {t}_{k} , {X}_{k} ) \\ callvalue ( {t}_{k} , {X}_{k} ) if ε {Y}_{k} < call v a l u e ( {t}_{k} , {X}_{k} )\end{matrix} . \qquad ( Equation 10 )$$

In various embodiments, the value of the callable instrument at the possible exercise date and/or call date tₖ (e.g., Yₖ) is reset to the call value when εYₖ<callvalue(tₖ,Xₖ) for a Bermudan option and/or other callable instruments where the holder of the callable instrument as the right to exercise the callable instrument on the possible exercise date and/or call date tₖ. In various embodiments, when the issuer has the right to exercise the callable instrument on the possible exercise date and/or call date tₖ, for example as is the case with a callable yield note, the value of the callable instrument at the possible exercise date and/or call date tₖ (e.g., Yₖ) is reset to the call value when εYₖ>callvalue(tₖ,Xₖ). Thus, in an example embodiment, for a callable instrument where the issuer has the right to exercise the callable instrument on the possible exercise date and/or call date tₖ, the value of the callable instrument is

$${Y}_{k} = \{ \begin{matrix}{Y}_{k} if ε {Y}_{k} \leq callvalue ( {t}_{k} , {X}_{k} ) \\ callvalue ( {t}_{k} , {X}_{k} ) if ε {Y}_{k} > callvalue ( {t}_{k} , {X}_{k} )\end{matrix} . \qquad ( Equation 11 )$$

In various embodiments, resetting the value of the callable instrument in this manner increases the accuracy of the resulting initial price of the callable instrument and/or other values of the callable instrument pricing information/data.

Thus, in various embodiments, the Backward DNN with Value Reset Solver generates M paths of an underlying entity (e.g., stock, index, and/or the like) Xᵢ (shorthand for Xₜ_{ᵢ}), where M is a positive integer. In various embodiments, the M paths are Monte Carlo paths of the underling stock or index. In an example embodiment, the M paths are sampled by a Euler scheme through

Xᵢ₊₁=Xᵢ+μ(tᵢ,Xᵢ)hᵢ+σ(tᵢ,Xᵢ)dWᵢ. (Equation 12)

Thus, for each of the M paths, the values of the underlying entity (e.g., stock, index, and/or the like) Xᵢ are estimated at each time tᵢ ∈{tᵢ|i=0, . . . , N} based on the value of the underlying entity at the initial time (e.g., X₀) and propagating forward through time to the maturity date and/or expiry date T=t_{N}. Thus, the value of the underlying entity at the maturity date and/or expiry date X_{N}^{(j)} for the jth path is determined.

For each of the M paths, the payoff value or value of the callable instrument at the maturity date and/or expiry date Y_{N} may be determined. For example, for the jth path, Y_{N}^{(j)}=g(X_{N}^{(j)}). In various embodiments, the value of the callable instrument is then propagated backward in time from the maturity date and/or expiry date to the initial time. At each time tᵢ, given Yᵢ₊₁, a DNN approximation is used for Zᵢ, as Zᵢ(θᵢ) for parameter θᵢ of the DNN using a sampled value of the underlying entity (e.g., stock, index, and/or the like) Xᵢ. For example, using Equation 9, the value of the callable instrument may be propagated backward in time from the determined callable instrument value Yᵢ₊₁ corresponding to time tᵢ₊₁ to the callable instrument value Yᵢ at time tᵢ. For example, along each of the M paths, as propagating the callable instrument value backward from time T to t₀=0, the initial value of the callable instrument for the jth path Y₀^{(j)} is estimated as a function of X₀, Z₀, and θ^{(j)}, where θ^{(j)}={θ₀^{(j)}, θ₁^{(j)}, . . . , θ_{(N-1)}^{(j)}} are the parameters for a neural network at each time step for the jth path.

In various embodiments, as the value of the callable instrument is being propagated backward from the maturity date and/or expiry date T to the initial time t₀=0, at one or more possible exercise dates and/or call dates tₖ, the least square regression is performed and the callable instrument value Yₖ of each path is reset according to Equation 10 (when the holder has the right to exercise and/or call the callable instrument) or Equation 11 (when the issuer has the right to exercise and/or call the callable instrument).

Once the initial value of the callable instrument Y₀ is determined for each path, the loss function L may be used, alongside an optimization strategy, to minimize the loss function L. For example, the parameters θ^{(j)}={θ₀^{(j)}, θ₁^{(j)}, . . . , θ_{(N-1)}^{(j)}} of the DNN may be tuned, modified, updated, and/or the like in order to minimize the loss function L. In various embodiments, minimizing the loss function L works to minimize a statistical measure of spread of the initial value of the callable instrument for each of the M paths. In an example embodiment, the optimization strategy is Adam optimization.

For example, multiple iterations of determining the initial value of the callable instrument for a plurality of paths {Yₒ^{(j)}}_{0≤j≤M} (projecting and/or propagating the final value of the callable instrument backward through the intermediate values of the callable instrument and back to the initial value of the callable instrument) may be performed as the parameters {θᵢ^{(j)}}_{0≤i≤N-1} of the backward DNN with value reset solver are modified and/or adjusted to minimize the loss function L. For example, the determination of the set of initial values {Yₒ^{(j)}}_{0≤j≤M} may be iterated until a convergence requirement is met (e.g., the statistical measure of spread satisfies a spread threshold requirement (e.g., is smaller than a spread threshold), the number of iterations reaches a set maximum iteration number, and/or the like). In an example embodiment, a stochastic gradient descent algorithm is used to optimize the parameters {θ^{(j)}} of the backward DNN with value reset solver and to minimize loss function L.

Once, the loss function L has been minimized, the initial price [symbol] (e.g., at t₀) is determined. In an example embodiment, the initial price [symbol] is the average and/or mean initial value of the plurality of paths, such that [symbol] =Mean_{all paths}(Y₀^{(j)}).

As should be understood, the backward DNN with value reset solver may be extended to high-dimensional problems such as high-dimensional derivative pricing. An example high-dimensional derivative pricing problem that may be addressed by the Backward DNN with Value Reset Soler is a callable instrument comprising a plurality of underlying entities (e.g., stocks, indices, and/or the like) such that Y=Y(X¹, X², . . . , X^{d}).

As should be understood, the DNN of the backward DNN with value reset solver learns to approximate the option price gradients via the adjustment, modification, refinement, and/or the like of the parameters {θ^{(j)}} of the DNN of the backward DNN with value reset solver. Thus, the initial price of the callable instrument is not determined based on model assumptions but are rather determined through the backward DNN with value reset solver using the trained DNN.

FIG. 4 provides a block diagram showing an example architecture of a backward DNN with value reset solver 400, in accordance with an example embodiment described herein. The input layers 402 are configured to receive a path {Xᵢ|i=0, . . . , N} and the corresponding Brownian motion path {Wᵢ|i=0, . . . , N}. The hidden layers 404 receive information/data from the input layers 402, apply the parameters {θᵢ|i=0, . . . , N} of the DNN of the backward DNN with value reset solver and provide information/data to the one or more output layers 406. In various embodiments, the hidden layers 404 comprise one to ten hidden layers. For example, in an example embodiment, the hidden layers 404 comprise four hidden layers. In another example embodiment, the hidden layers 404 comprise two hidden layers. In various embodiments, the output layers 406 provide the set of callable instrument values {Yᵢ|i=0, . . . , N} and the set of Z terms {Zᵢ|i=0, . . . , N−1}. In various example embodiments, the output layer may only provide the set of the callable instrument values {Yᵢ|i=0, . . . , N} or the Z terms {Zᵢ|i=0, . . . , N−1}. For example, the determination of the set of callable instrument values {Yᵢ|i=0, . . . , N} may be performed by the backward DNN with value reset solver outside of the DNN of the backward DNN with value reset solver based on the set of Z terms {Zᵢ|i=0, . . . , N−1} provided via the output layers of the DNN of the backward DNN with value reset solver.

In an example embodiment, each of the sub-neural networks configured for approximating Zᵢ(θᵢ) consists of four layers. For example, in an example embodiment, each sub-neural network comprises one d-dimensional input layer, where d is the number of underlying entities (e.g., stocks, indices, and/or the like) of the callable instrument, two hidden layers having d+10 dimensionality, and one d-dimensional output layer.

In various embodiments, a reset function 408 may act to reset the value of the callable instrument on one or more possible exercise dates and/or call dates tₖ. In an example embodiment, the reset function 408 may perform a least square regression analysis based on the corresponding underlying entity (e.g., stock, index, and/or the like) value (e.g., Xₖ) to determine an expected callable instrument value εYₖ at time tₖ. In instances where the expected callable instrument value is less than the call value of the callable instrument (e.g., determined based on terms and conditions of the callable instrument), the value of the callable instrument Yₖ is reset to the call value of the callable instrument at time tₖ.

As can be seen from FIG. 4, the backward DNN with value reset solver includes four types of connections. The first type of connection, (Xᵢ,W(tᵢ₊₁)−W(tᵢ))→Xᵢ₊₁ is characterized by Equation 12. Thus, there are no weights and/or parameters to be optimized for this first type of connection. The second type of connection, Xᵢ→θᵢ¹→θᵢ²→ . . . →θᵢ^{H}→Zᵢ is the multilayer feedforward neural network of the backward DNN with value reset solver 400 approximating the gradients describing the sensitivity of the callable instrument to the underlying entity (e.g., stock, index, and/or the like) at time tᵢ. For each point in time tᵢ, there are H hidden layers θᵢ¹, . . . , θᵢ^{H}. The parameters θᵢ of this sub-network are optimized through the minimization of the loss function L (e.g., the minimization of the statistical measure of spread of the set of initial values of the callable instrument for the plurality of paths). In particular, the parameters θᵢ describe and/or control the linear/nonlinear transformation from the input layers 402 to the first hidden layer θᵢ¹, between the hidden layers, and from the last hidden layer θᵢ^{H} to the output layer 406. The weights and/or parameters θᵢ include any potential batch-normalization parameters involved in the process as well, in an example embodiment. The third type of connection, (Yᵢ₊₁,Zᵢ, W(tᵢ₊₁)−W(tᵢ))→Yᵢ is the backward iteration that results in the approximation of the value of the callable instrument at time tᵢ (e.g., Yᵢ) based on the value of the callable instrument at time tᵢ₊₁ (e.g., Yᵢ₊₁), which is completely characterized by Equation 9. Thus, there are no parameters to be optimized for this third type of connection. The fourth connection is the reset of the value of the callable instrument based at a possible exercise date and/or call date tₖ. This connection is characterized by Equation 10 (when the holder has the right to exercise and/or call the callable instrument) or Equation 11 (when the issuer has the right to exercise and/or call the callable instrument). Thus, there are no parameters to be optimized for this fourth type of connection.

A marked advantage of the backward DNN with value reset solver, compared to traditional methods that determine an initial price and then project the price forward in time to determine the value of the callable instrument, is the ability to price callable instruments having multiple exercise dates in a computationally efficient manner (e.g., computationally efficient in terms of time and computational power).

### Example Operation of a Model Computing Device

In various embodiments, a model computing device 10 is configured to determine callable instrument pricing information/data using the backward DNN with value reset solver. For example, an initial callable instrument price may be determined using the backward DNN with value reset solver. In various embodiments, a value of the callable instrument at one or more possible exercise dates and/or call dates may be determined using the backward DNN with value reset solver.

### Determining Callable Instrument Pricing Information/Data

FIG. 5 provides flowchart illustrating operations performed, such as by the model computing device of FIG. 2 to provide callable instrument values, in accordance with an example embodiment described herein. In various embodiments, the callable instrument values may be used to price a callable instrument, determine a call strategy for a callable instrument, evaluate a portfolio comprising the callable instrument, and/or the like. In an example embodiment, the call strategy for the callable instrument may be automatically executed (e.g., via execution of computer-executable instructions by the model computing device 10).

Starting at block 502, a request for callable instrument pricing is received. For example, the model computing device 10 may receive a request for callable instrument pricing. For example, the model computing device 10 may comprise means, such as processor 12, memory 14, communications interface 16, user interface 18, and/or the like, for receiving a request for callable instrument pricing. In various embodiments, the request for callable instrument pricing comprises and/or indicates one or more terms and/or features of the callable instrument to be priced. For example, the request for callable instrument pricing may include a corresponding one or more underlying entities (e.g., stocks, indices, and/or the like); one or more exercise dates; an origination date (e.g., t₀), a maturity date and/or expiry date (e.g., t_{N}), one or more possible exercise dates and/or call dates {tₖ}, and/or various other terms of the callable instrument instrument.

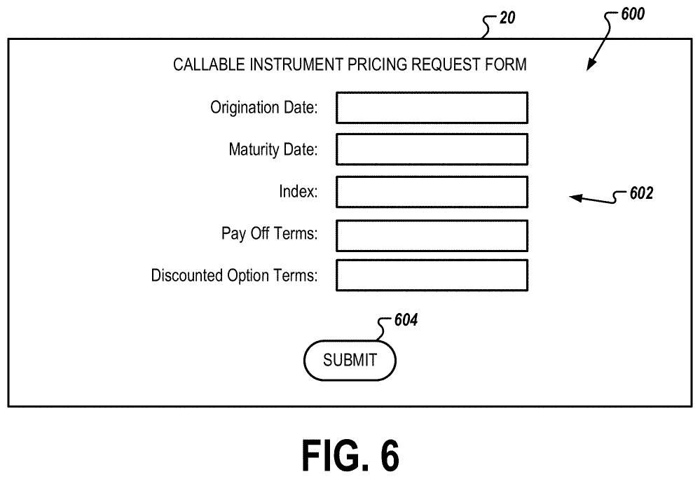

In an example embodiment, the request is automatically generated by the model computing device 10 (e.g., in response to a set and/or programmed trigger). In various embodiments, the request is generated and provided by a user computing device 20 in response to user interaction with an interactive user interface (IUI) provided via the input-output circuitry 28 of the user computing device 20. For example, the user computing device 20 may provide a callable instrument pricing request IUI 600, an example version of which is provided in FIG. 6. For example, the user computing device 20 may execute application program code to provide the callable instrument pricing request IUI 600. In various embodiments, the application program code corresponds to a dedicated application; a browser used to access a portal, website, dashboard and/or the like (e.g., provided and/or hosted by the model computing device 10 and/or the like); or other application. In various embodiments, the callable instrument pricing request IUI 600 comprises one or more fillable and/or selectable instrument information/data fields 602. For example, the user may provide input (e.g., via input-output circuitry 28) to cause one or more fillable and/or selectable instrument information/data fields 602 to be populated by the user computing device 20. The user may then select (e.g., via input-output circuitry 28) a selectable submit element 604 (e.g., a submit button, icon, and/or the like) to cause the user computing device 20 to generate the request for callable instrument pricing and provide (e.g., transmit) the request for callable instrument pricing such that the model computing device 10 receives the request for callable instrument pricing. For example, the user computing device 20 may comprise means, such as processor 22, memory 24, communications interface 26, input-output circuitry 28, and/or the like, for receiving user input (e.g., via a callable instrument pricing request IUI 600), generate a request for callable instrument pricing, and provide the request for callable instrument pricing.

Continuing with FIG. 5, at block 504, the model computing device 10 may define a set of dates {tᵢ|i=0, 1, . . . , N}. The set of dates includes the possible exercise dates and/or call dates {tₖ} for the callable instrument to be priced (e.g., based on information/data contained in the request for callable instrument pricing). For example, the possible exercise dates and/or call dates {tₖ} are a subset of the set of dates {tᵢ} (e.g., {tₖ}⊆{tᵢ}). For example, the model computing device 10 may define the set of dates. In various embodiments, the set of dates are a time-ordered set (e.g., the earliest date is the first date of the set of dates and the latest date is the final date of the set of dates). For example, t₀<t₁< . . . <t_{N-2}<t_{N-1}, for each date in the set of dates. For example, the model computing device 10 may comprise means, such as processor 12, memory 14, solver circuitry 202, and/or the like, for defining the set of dates. In an example embodiment, the set of dates are defined by the backward DNN with value reset solver (e.g., a portion of and/or executable computer code exterior to the DNN of the backward DNN with value reset solver).

At block 506, the model computing device 10 may determine a set of underlying entity values (e.g., {Xᵢ|i=0, 1, . . . , N}). For example, in the above example, the value of the underlying entity (e.g., stock, index, and/or the like) {Xᵢ|i=0, 1, . . . , N} and the Brownian motion path {W(tᵢ)|i=0, 1, . . . , N} for a plurality (e.g., M) paths are determined. For example, the inputs to the DNN of the backward DNN with value reset solver may be determined (e.g., possibly by a portion of and/or executable computer code the backward DNN with value reset solver that is exterior to the DNN itself). For example, the model computing device 10 may determine a set of underlying entity values (e.g., underlying stock and/or index values) and/or other inputs (e.g., Brownian motion path(s)) of the DNN of the backward DNN with value reset solver. For example, the model computing device 10 may comprise means, such as processor 12, memory 14, solver circuitry 202, and/or the like, for determining a set of index values and/or other inputs of the DNN of the backward DNN with value reset solver. In various embodiments, the set of underlying entity values and/or other inputs of the DNN of the backward DNN with value reset solver may be determined, at least in part based on information/data provided in the callable instrument pricing request. In various embodiments, the set of underlying entity values and/or other inputs of the DNN of the backward DNN with value reset solver may define a plurality of paths. In an example embodiment, each of the plurality of paths (and/or at least some of the plurality of paths) are Monte Carlo paths. In various embodiments, M paths are determined, where M is in the range of 2,000 to 5,000. In various embodiments, M is larger than 5,000 or smaller than 2,000, as appropriate for the application. For each path, a final callable instrument value may be determined based on the final underlying entity value(s) and the payoff function of the callable instrument (e.g., Y_{T}=g(X_{T})=g(X_{T}¹, X_{T}², . . . , X_{T}^{d})).

At block 508, the DNN (e.g., processor 12 and/or DNN circuitry 204) of the backward DNN with value reset solver is used to iterate the final callable instrument value (e.g., Y_{T}), back through the intermediate callable instrument values (e.g., Yᵢ for i=1, 2, . . . , N−1), back to the initial callable instrument value (e.g., Y₀), for each of the plurality of paths. In various embodiments, the determination of each of the callable instrument values Yᵢ is determined through a single iteration of the DNN. For example, the model computing device 10 may determine initial callable instrument value Y₀ and the intermediate callable instrument values {Yᵢ|i=1, 2, . . . , N−1} for each path by iterating backwards in time from the corresponding final callable instrument value Y_{T}. For example, the model computing device 10 may comprise means, such as processor 12, memory 14, solver circuitry 202, DNN circuitry 204, and/or the like, for determining initial callable instrument value Y₀ and the intermediate callable instrument value {Yᵢ|i=1, 2, . . . , N−1} for each path by iterating backwards in time from the corresponding final callable instrument value Y_{T}. For example, a set of initial values {Y₀^{(j)}}_{0≤j≤M} (e.g., including an initial callable instrument value for each of the plurality (e.g., M) of paths) may be generated.

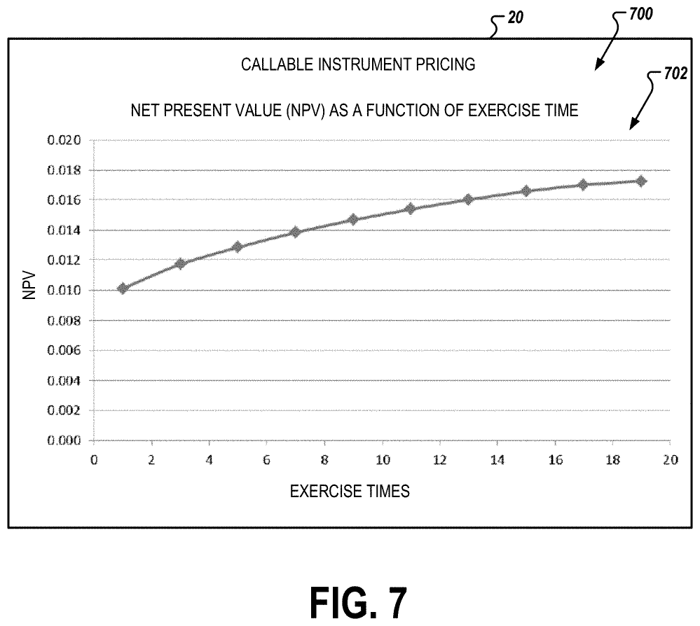

In various embodiments, at one or more of the possible exercise dates and/or call dates tₖ. It may be determined if the value of the callable instrument should be reset. For example, an expected value of the callable instrument may be determined at a possible exercise date and/or call date tₖ based on a least square regression of the relationship between the underlying entity value and the callable instrument value. For example, as described by Equation 10 (when the holder has the right to exercise and/or call the callable instrument) or Equation 11 (when the issuer has the right to exercise and/or call the callable instrument) above, the expected value of the callable instrument at a possible exercise date and/or call date tₖ may be compared to the call value of the callable instrument at the possible exercise date and/or call date tₖ. If the expected value of the callable instrument at the possible exercise date and/or call date tₖ is less than the call value of the callable instrument at the possible exercise date and/or call date tₖ, the value of the callable instrument at the possible exercise date and/or call date tₖ may be reset to the call value of the callable instrument at the possible exercise date and/or call date tₖ. The reset process will be described in more detail with respect to FIG. 7.

At block 510, the model computing device 10 may determine if a convergence requirement is satisfied. For example, the model computing device 10 may comprise means, such as processor 12, memory 14, solver circuitry 202, DNN circuitry 204, and/or the like, for determining if the convergence requirement is satisfied. In an example embodiment, the convergence requirement is a defined maximum number of iterations. In an example embodiment, the convergence requirement is a spread threshold requirement corresponding to a statistical measure of spread (e.g., variance, standard deviation, and/or the like) of the set of initial callable instrument values {Y₀^{(j)}}. For example, the spread threshold requirement may be satisfied when the statistical measure of spread of the set of initial values {Y₀^{(j)}} is smaller than a spread threshold. For example, a statistical measure of spread of the set of initial values may be determined and compared to a spread threshold to determine if the spread threshold requirement (and thus the convergence requirement) is satisfied.

When, at block 510, it is determined that the convergence requirement is not satisfied, the process continues to block 512. At block 512, the model computing device 10 may modify, adjust, refine, and/or the like the parameters θᵢ of the backward DNN with value reset solver. For example, a loss function may be determined (e.g., based on the set of initial values of the callable instrument and/or statistical measure of spread of the set of initial values of the callable instrument) and the loss function may be used to modify, adjust, refine, and/or the like the parameters θᵢ of the DNN of the backward DNN with value reset solver. For example, in an example embodiment, a stochastic gradient descent algorithm may be used to modify, adjust, refine, and/or the like the parameters θᵢ of the DNN of the backward DNN with value reset solver to minimize the loss function (and/or the measure of spread of the set of initial values of the callable instrument). For example, the model computing device 10 may modify, adjust, refine, and/or the like the parameters θᵢ of the DNN of the backward DNN with value reset solver. For example, the model computing device 10 may comprise means, such as processor 12, memory 14, solver circuitry 202, DNN circuitry 204, and/or the like, for modifying, adjusting, refining, and/or the like the parameters θᵢ of the DNN of the backward DNN with value reset solver.

When, at block 510, it is determined that the convergence requirement is satisfied, the process continues to block 514. At block 514, the callable instrument pricing information/data is determined (e.g., based on the output of the DNN of the backward DNN with value reset solver). For example, the model computing device 10 may determine the callable instrument pricing information/data. For example, the model computing device 10 may comprise means, such as processor 12, memory 14, solver circuitry 202, DNN circuitry 204, and/or the like, for determining the callable instrument pricing information/data. For example, the initial callable instrument price [symbol] is set as the average initial value of the callable instrument based on the plurality (e.g., M) of paths. For example,

$$= \frac{1}{M} {\sum }_{j = 0}^{M - 1} {Y}_{0}^{( j )} .$$

In various embodiments, the callable instrument pricing information/data may include the initial callable instrument price, the value of the callable instrument at one or more possible exercise dates and/or call dates, and/or the like. In various embodiments, the value of the callable instrument at an exercise date is the average (e.g., mean) of the value of the callable instrument at the exercise date for each of the plurality of paths

$$( e . g . , = \frac{1}{M} {\sum }_{j = 0}^{M - 1} {Y}_{k}^{( j )} ) .$$

The callable instrument pricing information/data is then provided such that the user computing entity 20 receives the callable instrument pricing information/data. For example, the model computing device 10 may provide the callable instrument pricing information/data such that the user computing entity 20 receives the callable instrument pricing information/data. For example, the model computing device 10 may comprise means, such as processor 12, memory 14, communications interface 16, and/or the like, for providing the callable instrument pricing information/data such that the user computing entity 20 receives the callable instrument pricing information/data.

In various embodiments, the user computing device 20 receives the callable instrument pricing information/data. For example, the user computing device 20 may comprise means, such as processor 22, memory 24, communications interface 26, and/or the like for receiving the callable instrument pricing information/data. The user computing device 20 may register and/or process the callable instrument pricing information/data (e.g., via processor 22) and generate and/or render a representation of at least a portion of the callable instrument pricing information/data. For example, a graphical and/or tabular representation of at least a portion of the callable instrument pricing information/data may be generated and/or rendered. The representation of the at least a portion of the callable instrument information/data may then be provided (e.g., displayed) via the input-output circuitry 28 of the user computing device 20. For example, the user computing device 20 may execute application program code to provide a callable instrument pricing IUI 700 via the input-output circuitry 28, an example version of which is shown in FIG. 7. In various embodiments, the application program code corresponds to a dedicated application; a browser used to access a portal, website, dashboard and/or the like (e.g., provided and/or hosted by the model computing device 10 and/or the like); or other application. As shown in FIG. 7, a callable instrument pricing IUI 700 may comprise a representation 702 of at least a portion of the callable instrument information/data. For example, the representation 702 provides a graph of net present value (e.g., initial price of the callable instrument, value of the callable instrument at an exercise date, hold value of the callable instrument, and/or the like) with respect to exercise time.

In various embodiments, a human or machine user of a user computing device 20 may use at least a portion of the callable instrument pricing information/data to make one or more decisions. For example, the human or machine user may choose to exercise an option corresponding to the callable instrument or to purchase or provide the callable instrument based on the at least a portion of the callable instrument pricing information/data and/or representation thereof. In an example embodiment, the decisions may need to be made on a relatively short time frame (e.g., less than five minutes, less than fifteen minutes, less than half an hour, and/or the like). In various embodiments, the callable instrument pricing information/data is generated and provided in real time or near real time, by the model computing device 10, with respect to the receiving of the request for callable instrument pricing, by the model computing device 10.

In an example embodiment, the user is a model validation machine user that is a model validation module, application, program, and/or the like configured to compare at least a portion of the callable instrument pricing information/data to model determined callable instrument information/data to validate a callable instrument model and/or the model determined callable instrument information/data. For example, a callable instrument model that is external to the backward DNN with value reset solver may generate model determined callable instrument information/data that corresponds to the callable instrument pricing information/data. For example, the model determined callable instrument information/data may include the initial callable instrument price, the value of the callable instrument at one or more exercise dates, and/or the like for the same, substantially the same, and/or similar callable instrument as the callable instrument pricing information/data determined by the backward DNN with value reset solver. The callable instrument model may be part of a line-of-business (LOB) program package or may be another callable instrument model that is otherwise separate from the backward DNN with value reset solver. In an example embodiment, the model validation machine user may comprise computer executable program code operating on the model computing device 10, a user computing device 20, and/or the like.

In various embodiments, the model validation machine user is configured and/or programmed to compare one or more elements of the model determined callable instrument information/data and the callable instrument pricing information/data to determine if the model determined callable instrument information/data and the callable instrument pricing information/data satisfy a similarity requirement. In an example embodiment, if the ratio of initial callable instrument price, for example, of the model determined callable instrument information/data to the initial callable instrument price of the callable instrument pricing information/data is within a defined range (e.g., 0.8 to 1.25, 0.85 to 1.17, 0.9 to 1.11, 0.95 to 1.05, 0.98 to 1.02, 0.99 to 1.01, and/or the like), it may be determined that the model determined callable instrument information/data and the callable instrument pricing information/data satisfy the similarity requirement. Similarly, if the ratio of the initial callable instrument price of the model determined callable instrument information/data to the initial callable instrument price of the callable instrument pricing information/data is not within the defined range, the model validation machine user may determine that the similarity requirement is not satisfied. In an example embodiment, if the absolute value of the difference between the initial callable instrument price, for example, of the model determined callable instrument information/data and the initial callable instrument price of the callable instrument pricing information/data or the absolute value of the difference between the initial callable instrument price of the model determined callable instrument information/data and the initial callable instrument price of the callable instrument pricing information/data divided by some value (e.g., the initial callable instrument price of the model determined callable instrument information/data or the callable instrument pricing information/data) is less than a threshold value, it may be determined that the similarity requirement is satisfied. Similarly, if the absolute value of the difference between the initial callable instrument price, for example, of the model determined callable instrument information/data and the initial callable instrument priced of the callable instrument pricing information/data or the absolute value of the difference between the initial callable instrument price of the model determined callable instrument information/data and the initial callable instrument price of the callable instrument pricing information/data divided by some value (e.g., the initial callable instrument price of the model determined callable instrument information/data or the callable instrument pricing information/data) is not less than the threshold value, the model validation machine user may determine that the similarity requirement is not satisfied.

When the similarity requirement is satisfied, the model validation machine user may cause the callable instrument information/data to be stored, a log to be updated indicating that the similarity requirement was satisfied, and/or the like. When the similarity requirement is not satisfied, the model validation machine user may cause the callable instrument information/data to be stored, a log to be updated indicating that the similarity requirement was not satisfied, generate and cause an alert to be provided (e.g., via the IUI of the user computing device 20, via an email, instant message, and/or the like), and/or otherwise provide feedback to one or more human users or other machine users that the similarity requirement was not satisfied. In an example embodiment, providing the alert includes causing a representation of the at least a portion of the callable instrument information/data to be provided (e.g., displayed) via the input-output circuitry 28 of the user computing device 20, a representation of at least a portion of the model determined callable instrument information/data to be provided (e.g., displayed) via the input-output circuitry 28 of the user computing device 20, an identification of the callable instrument model that did not satisfy the similarity requirement, information/data identifying the callable model for which the callable instrument model that did not satisfy the similarity requirement, an indication that the similarity requirement was not satisfied, and/or the like, and/or various combinations thereof.

### Performing a Value Reset

As noted above, the backward DNN with value reset solver is configured to determine if the value of the callable instrument should be reset at one or more possible exercise dates and/or call dates of the callable instrument. When the backward DNN with value reset solver determines that the value of the callable instrument should be reset, at a possible exercise date and/or call date of the callable instrument, the backward DNN with value reset solver resets the value of the callable instrument. For example, in various embodiments, the backward DNN with value reset solver resets the value of the callable instrument at possible exercise date and/or call date tₖ as the call value of the callable instrument at possible exercise date and/or call date tₖ. In various embodiments, the value reset is performed in accordance with Equation 10 (when the holder has the right to exercise and/or call the callable instrument) or Equation 11 (when the issuer has the right to exercise and/or call the callable instrument) above.

FIG. 8 provides flowchart illustrating operations performed, such as by the model computing device of FIG. 2 to perform a value reset for a callable instrument, in accordance with an example embodiment described herein. In various embodiments, the operations illustrated in FIG. 8 occur during block 508 of FIG. 5. Starting at block 802, the model computing device 10 may determine the value of the callable instrument Yᵢ at time tᵢ. For example, time tᵢ is a member of the set of dates {tᵢ|i=0, 1, . . . , N} defined at block 504. In various embodiments, the value of the callable instrument Yᵢ at time tᵢ is determined based on the value of the callable instrument Yᵢ₊₁ at time tᵢ₊₁ in accordance with Equation 9. For example, the model computing device 10 may determine the value of the callable instrument Yᵢ at time tᵢ based on the value of the callable instrument Yᵢ₊₁ at time tᵢ₊₁. For example, the model computing device 10 may comprise means, such as processor 12, memory 14, solver circuitry 202, DNN circuitry 204, and/or the like, for determining the value of the callable instrument Yᵢ at time tᵢ based on the value of the callable instrument Yᵢ₊₁ at time tᵢ₊₁.

At block 804, the model computing device 10 may determine if time tᵢ is a possible exercise date and/or call date. For example, as noted above, the possible exercise dates and/or call dates {tₖ} of the callable instrument are a subset of the set of dates {tᵢ|i=0, 1, . . . , N} defined at block 504. Therefore, it is determined if the time tᵢ is one of the possible exercise dates and/or call dates {tₖ} of the callable instrument. For example, the model computing device 10 may determine if the time tᵢ is one of the possible exercise dates and/or call dates {tₖ} of the callable instrument. For example, the model computing device 10 may comprise means such as processor 12, memory 14, solver circuitry 202, DNN circuitry 204, and/or the like, for determining if the time tᵢ is one of the possible exercise dates and/or call dates {tₖ} of the callable instrument. In an example embodiment, the model computing device 10 may query a list of possible exercise dates and/or call dates for the callable instrument to determine if the time tᵢ is one of the possible exercise dates and/or call dates {tₖ} of the callable instrument. In an example embodiment, the possible exercise dates and/or call dates {tₖ} are flagged within the set of dates {tᵢ|i=0, 1, . . . , N} defined at block 504, and it may be determined if the time tᵢ is one of the possible exercise dates and/or call dates {tₖ} (e.g., whether tᵢ∈{tₖ}) based on the whether the time tᵢ is associated with a possible exercise date and/or call date flag.

When, at block 804, the model computing device 10 determines that the time tᵢ is not a possible exercise date and/or call date of the callable instrument (e.g., tᵢ∉{tₖ}), the value of the callable instrument is not reset and the process continues to block 816.

When at block 804, the model computing device 10 determines that the time tᵢ is a possible exercise date and/or call date of the callable instrument (e.g., tᵢ∈{tₖ}), the process continues to block 806. At block 806, the model computing device 10 uses a regression analysis (e.g., a least square regression analysis) to determine an expected value of the callable instrument at time tᵢ. For example, a regression analysis may be used to determine an expected value εYᵢ of the callable instrument at time tᵢ based on the value of the underlying entity (e.g., stock, index, and/or the like) at the time tᵢ (e.g., Xᵢ). In various embodiments, the regression analysis is performed on at least a subset of the plurality of paths. The subset of the plurality of paths and/or whether all of the plurality of paths are used in the regression analysis is determined based on the callable instrument. For example, when the callable instrument is a Bermudan option, the regression analysis is performed using the subset of the plurality of paths consisting of paths that have a positive call value for the Bermudan option at the time tᵢ. In another example, all of the plurality of paths may be used in performing the regression analysis when the callable instrument is a callable yield note.

As should be understood, various basis functions may be used to perform the least square regression. For example, in an example embodiment, the basis function is a quadratic function (e.g., εYᵢ=a+bXᵢ+cXᵢ²). For example, in an example embodiment, weighted Laguerre polynomials are used as the basis function for performing the least square regression. The least square regression may be performed over each of the paths (e.g., at possible exercise dates and/or call having a positive call value). For example, the model computing device 10 may perform a regression analysis of the value of the callable instrument with respect to the value of the underlying entity (e.g., stock, index, and/or the like) to determine an expected value for the callable instrument at time tᵢ. For example, the model computing device 10 may comprise means, such as processor 12, memory 14, solver circuitry 202, and/or the like for performing a regression analysis of the value of the callable instrument with respect to the value of the underlying entity (e.g., stock, index, and/or the like) to determine an expected value for the callable instrument at time tᵢ.

At block 808, the model computing device 10 may determine a call value for the callable instrument at the possible exercise date and/or call date (e.g., at time tᵢ). Equation 8 provides an example of determining a call value for a callable instrument when the callable instrument is a Bermuda option. For example, the call value for the callable instrument at time tᵢ may be determined based on the value of the underlying entity (e.g., stock, index, and/or the like) at time tᵢ (e.g., Xᵢ). In various embodiments, the call value for the callable instrument at time tᵢ is determined based on the terms of the callable instrument. For example, the model computing device 10 may determine a call value for the callable instrument at the time tᵢ. For example, the model computing device 10 may comprise means, such as processor 12, memory 14, solver circuitry 202, and/or the like, for determining a call value for the callable instrument at time tᵢ.

At block 810, the model computing device 10 may determine if the expected value of the callable instrument at time tᵢ (e.g., εYᵢ) is greater than or equal to the call value of the callable instrument at time tᵢ. For example, the expected value of the callable instrument at time tᵢ (e.g., εYᵢ) is compared to the call value of the callable instrument at time tᵢ to determine if the expected value of the callable instrument at time tᵢ (e.g., εYᵢ) is greater than or equal to the call value of the callable instrument at time tᵢ. For example, the model computing device 10 may determine whether the expected value of the callable instrument at time tᵢ (e.g., εYᵢ) is greater than or equal to the call value of the callable instrument at time tᵢ. For example, the model computing device 10 may comprise means, such as processor 12, memory 14, solver circuitry 202, and/or the like, for determining whether the expected value of the callable instrument at time tᵢ (e.g., εYᵢ) is greater than or equal to the call value of the callable instrument at time tᵢ.

When, at block 810, it is determined that the expected value of the callable instrument at time tᵢ (e.g., εYᵢ) is greater than or equal to the call value of the callable instrument at time tᵢ, the process continues to block 812. At block 812, the model computing device 10 may determine that the value of the callable instrument at time tᵢ is not to be reset and the process continues to block 816 without resetting the value of the callable instrument. For example, responsive to determining that the expected value of the callable instrument at time tᵢ (e.g., εYᵢ) is greater than or equal to the call value of the callable instrument at time tᵢ, the model computing device 10 may determine that the value of the callable instrument at time tᵢ is not to be reset. For example, the value of the callable instrument at time tᵢ may not be modified from that determined based on the output of the DNN of the backward DNN with value reset solver. For example, the model computing device 10 may comprise means, such as processor 12, memory 14, solver circuitry 202, and/or the like, for determining, responsive to determining that the expected value of the callable instrument at time tᵢ (e.g., εYᵢ) is greater than or equal to the call value of the callable instrument at time tᵢ, that the value of the callable instrument at time tᵢ is not to be reset. The process may then continue to block 816.

When, at block 810, it is determined that the expected value of the callable instrument at time tᵢ (e.g., εYᵢ) is neither greater than nor equal to (e.g., is less than) the call value of the callable instrument at time tᵢ, the process continues to block 814. At block 814, the model computing device 10 may reset the value of the callable instrument at time tᵢ and the process continues to block 816 using the reset value of the callable instrument. In an example embodiment, the value of the callable instrument at time tᵢ is reset to a reset value. In an example embodiment, the reset value is the call value of the callable instrument at time tᵢ (which is a possible exercise date and/or call date). Equation 8 provides an example of determining a call value for a callable instrument when the callable instrument is a Bermuda option. For example, the model computing device 10 may reset the value of the callable instrument at time tᵢ to a reset value responsive to determining that the expected value of the callable instrument at time tᵢ (e.g., εYᵢ) is neither greater than nor equal to (e.g., is less than) the call value of the callable instrument at time tᵢ. For example, the model computing device 10 may comprise means, such as processor 12, memory 14, solver circuitry 202, and/or the like, for resetting the value of the callable instrument at time tᵢ to a reset value responsive to determining that the expected value of the callable instrument at time tᵢ (e.g., εYᵢ) is neither greater than nor equal to (e.g., is less than) the call value of the callable instrument at time tᵢ.

At block 816, the model computing device 10 may determine if the index i is equal to zero. For example, it may be determined if each of the dates of the set of dates {tᵢ} have been considered such that the initial value of the callable instrument (for the corresponding path) has been determined. For example, the model computing device 10 may determine if the index i is equal to zero. For example, the model computing device 10 may comprise means, such as processor 12, memory 14, solver circuitry 202, and/or the like for determining if the index i is equal to zero.

When, at block 816, it is determined that the index i is not equal to zero, the process continues to block 818. At block 818, the model computing device 10 iterates index i. For example, the value of the index i may be updated to i−1 (e.g., i→i−1). For example, the model computing device 10 may iterate the value of the index i. For example, the model computing device 10 may comprise means, such as processor 12, memory 14, solver circuitry 202, and/or the like for iterating the value of the index i.

When, at block 816, it is determined that the index i is equal to zero, the process continues to block 820. At block 820, the model computing device 10 may provide one or more values of the callable instrument. For example, the model computing device 10 may comprise means, such as processor 12, memory 14, communication interface 16, solver circuitry 202, DNN circuitry 204, and/or the like for providing one or more values of the callable instrument. For example, the value of the callable instrument at one or more times may be provided (e.g., {Yᵢ|i=0, 1, . . . , N}). For example, the initial value of the callable instrument Y₀ may be provided. In various embodiments, the one or more values of the callable instrument (e.g., including the initial value of the callable instrument) are provided to the process of block 510. For example, the initial value of the callable instrument may be provided such that it may be determined if the convergence requirement has been satisfied. In an example embodiment, one or more values of the callable instrument are provided such that the callable instrument pricing information/data may be determined. As should be understood, the one or more values of the callable instrument correspond to a particular path of the plurality of paths being considered.

FIGS. 5 and 8 illustrates a flowchart describing sets of operations performed by apparatuses, methods, and computer program products according to various example embodiments. It will be understood that each block of the flowcharts, and combinations of blocks in the flowcharts, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computer or other programmable apparatus (e.g., hardware) to produce a machine, such that the resulting computer or other programmable apparatus implements the functions specified in the flowchart blocks. These software instructions may also be stored in a computer-readable memory that may direct a computer or other programmable apparatus to function in a particular manner, such that the software instructions stored in the computer-readable memory produce an article of manufacture, the execution of which implements the functions specified in the flowchart blocks. The software instructions may also be loaded onto a computer or other programmable apparatus to cause a series of operations to be performed on the computer or other programmable apparatus to produce a computer-implemented process such that the software instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Technical Advantages

As these examples illustrate, example embodiments contemplated herein provide technical solutions that solve real-world problems faced during the pricing of callable instruments and the pricing of callable instruments having multiple exercise dates, in particular. Traditional means for pricing callable instruments, such as finite difference based PDE methods, are not able to handle the high dimensional nature of pricing callable instruments having multiple exercise dates. Monte Carlo methods for pricing callable instruments require an exponentially growing number of paths to evaluate the expected future value of a callable instrument. For example, Monte Carlo methods generally require evaluating more than a factor of ten more paths than the number of paths used by embodiments of the backward DNN with value reset solver. For example, an embodiment of the backward DNN with value reset solver uses 5,000 paths while, to solve the same problem, Monte Carlo methods require one billion paths. As such, Monte Carlo methods for pricing callable instruments are computationally expensive and inefficient. Various embodiments of the backward DNN with value reset solver therefore provide an improvement in the art and a technical improvement of increased computational efficiency compared to techniques known in the art for pricing callable instruments and callable instruments with multiple exercise dates in particular. Moreover, this increase in computational efficiency does not negatively affect the accuracy of the predictions provided by the backward DNN with value reset solver with respect to Monte Carlo methods. For example, in numerical tests performed by the inventors, the results provided by the backward DNN with value reset solver with within 0.25% (and often within 0.10%) of the results provided by the Monte Carlo method. However, in the numerical tests performed by the inventors, the backward DNN with value reset solver provided the results in a significantly faster time frame (and used significantly less computational power) than the Monte Carlo method. For example, when a 1,000,000 path Monte Carlo method and a 5,000 path backward DNN with value reset solver are used to address the same problem, the relative difference in the results is less than 0.5%. Thus, the backward DNN with value reset solver is significantly more computationally efficient than the Monte Carlo method.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method for training a reverse-time-order deep neural network (DNN) solver to determine an initial time result, the computer-implemented method comprising:
defining, by a model computing device, an array of dates comprising a plurality of time-ordered dates comprising an initial date t₀, a final date t_{f}, and a plurality of intermediate dates between the initial date and the final date, the plurality of intermediate dates comprising a particular date;
setting, by the model computing device, an architecture of the reverse-time-order DNN solver such that the reverse-time-order DNN solver comprises a plurality of DNNs, wherein each DNN of the plurality of DNNs (a) corresponds to a respective date that is a respective one of the initial date or a respective one of the plurality of intermediate dates and (b) is configured to determine an output gradient for the respective date, and the reverse-time-order DNN solver further comprises a reset function corresponding to the particular date of the array of dates,
determining, by the model computing device, a plurality of paths corresponding to a value of one or more underlying entities represented by a respective path, each path corresponding to the array of dates;
training, by the model computing device, the reverse-time-order DNN solver until a convergence requirement is satisfied,
wherein each DNN of the plurality of DNNs comprises (a) an input layer configured to receive a value of at least one path of the plurality of paths corresponding to the respective date, (b) one or more hidden layers configured to use one or more respective parameters to transform input received via the input layer into an output gradient,
wherein the reverse-time-order DNN solver is configured to (i) provide a respective value of a path of the plurality of paths and corresponding to a respective date to the input layer of each respective DNN of the plurality of DNNs, the respective DNN corresponding to the respective date, (ii) obtain a respective output gradient from the output layer of each respective DNN, (iii) determine a final value for the path based on a portion of the path corresponding to the final date, and (iv) determine a respective initial value for the path by propagating the final value backward in time by, for each date tᵢ of the set of dates where t₀<tᵢ<tᵢ₊₁<t_{f}, determining a respective intermediate value based on an expected value for date tᵢ₊₁ and the output gradient determined by the respective DNN corresponding to the respective date tᵢ, and, when tᵢ is the particular date, use the reset function (a) to determine an expected value corresponding to the particular date based on a regression analysis, (b) evaluate whether the expected value satisfies one or more criteria, (c) when the expected value satisfies the one or more criteria, replace the respective intermediate value corresponding to the particular date with the expected value, and (d) when the expected value does not satisfy the one or more criteria, maintain the respective intermediate value corresponding to the particular date,
the reverse-time-order DNN solver is trained by:
executing the reverse-time-order DNN solver to cause the reverse-time-order DNN solver to determine the respective initial value for each of one or more paths of the plurality of paths based at least in part on the respective output gradient determined by respective DNNs of the plurality of DNNs of the reverse-time-order DNN solver,
determining one or more statistical measures of spread based at least in part on the respective initial value, and
modifying at least one of the one or more respective parameters of each of two or more of the plurality of DNNs based on a result of determining the one or more statistical measures of spread;
after the convergence requirement is satisfied, determining, by the model computing device, an initial time result based at least in part on respective initial values determined by the reverse-time-order DNN solver for the plurality of paths; and
providing, by the model computing device, at least a portion of the initial time result such that at least one of (a) a program executing on a computing device receives the at least a portion of the initial time result as input or (b) a user computing device receives the at least a portion of the initial time result and provides a representation of the at least a portion of the initial time result via an interactive user interface provided via a display of the user computing device.

2. The computer-implemented method of claim 1, wherein evaluating the expected value corresponding to the particular date based on the one or more criteria comprises comparing the expected value to a call value of a callable instrument corresponding to the particular date.

3. The computer-implemented method of claim 2, wherein the one or more criteria are satisfied when (a) the expected value is less than the call value when a holder of the callable instrument has a right to exercise the callable instrument on the particular date or (b) the expected value is greater than the call value when an issuer of the callable instrument has a right to exercise the callable instrument on the particular date.

4. (canceled)

5. (canceled)

6. The computer-implemented method of claim 1, wherein the regression analysis is a least square regression analysis.

7. The computer-implemented method of claim 6, wherein the least square regression analysis determines an expected value at the particular date based on respective values of the one or more underlying entities at the particular date.

8. The computer-implemented method of claim 6, wherein a basis function of the least square regression is a quadratic function.

9. The computer-implemented method of claim 1, wherein the convergence requirement is at least one of (a) a set number of iterations performed or (b) at least one of the one or more statistical measures of spread satisfies a spread threshold requirement.

10. The computer-implemented method of claim 1, wherein the initial time result comprises at least one of an initial callable instrument price or a callable instrument value for one or more exercise dates of a callable instrument.

11. The computer-implemented method of claim 1, wherein the result of determining the one or more statistical measures of spread is used to modify the one or more respective parameters of each of the plurality of DNNs.

12. The computer-implemented method of claim 1, wherein the reverse-time-order DNN solver comprises at least one DNN that is a feedforward DNN.

13. The computer-implemented method of claim 1, wherein the final value corresponding to the final date of the array of dates is determined based on respective values of the one or more underlying entities corresponding to the final date.

14. (canceled)

15. An apparatus for training a reverse-time-order deep neural network (DNN) solver to determine an initial time result, the apparatus comprising:
processor circuitry configured to:
define an array of dates comprising a plurality of time-ordered dates comprising an initial date t₀, a final date t_{f}, and a plurality of intermediate dates between the initial date and the final date, the plurality of intermediate dates comprising a particular date;
set an architecture of the reverse-time-order DNN solver such that the reverse-time-order DNN solver comprises a plurality of DNNs, wherein each DNN of the plurality of DNNs (a) corresponds to a respective date that is a respective one of the initial date or a respective one of the plurality of intermediate dates and (b) is configured to determine an output gradient for the respective date, and the reverse-time-order DNN solver further comprises a reset function corresponding to the particular date of the array of dates,
determine a plurality of paths corresponding to a value of one or more underlying entities represented by a respective path, each path corresponding to the array of dates;
train the reverse-time-order DNN solver until a convergence requirement is satisfied,
wherein each DNN of the plurality of DNNs comprises (a) an input layer configured to receive a value of at least one path of the plurality of paths corresponding to the respective date, (b) one or more hidden layers configured to use one or more respective parameters to transform input received via the input layer into an output gradient, and (c) an output layer configured to provide the output gradient,
wherein the reverse-time-order DNN solver is configured to (i) provide a respective value of a path of the plurality of paths and corresponding to a respective date to the input layer of each respective DNN of the plurality of DNNs, the respective DNN corresponding to the respective date, (ii) obtain a respective output gradient from the output layer of each respective DNN, (iii) determine a final value for the path based on a portion of the path corresponding to the final date, and (iv) determine a respective initial value for the path by propagating the final value backward in time by, for each date tᵢ of the set of dates where t₀<tᵢ<tᵢ₊₁<t_{f}, determining a respective intermediate value based on an expected value for date tᵢ₊₁ and the output gradient determined by the respective DNN corresponding to the respective date tᵢ, and, when tᵢ is the particular date, use the reset function (a) to determine an expected value corresponding to the particular date based on a regression analysis, (b) evaluate whether the expected value satisfies one or more criteria, (c) when the expected value satisfies the one or more criteria, replace the respective intermediate value corresponding to the particular date with the expected value, and (d) when the expected value does not satisfy the one or more criteria, maintain the respective intermediate value corresponding to the particular date,
the reverse-time-order DNN solver is trained by:
executing the reverse-time-order DNN solver to cause the reverse-time-order DNN solver to determine the respective initial value for each of one or more paths of the plurality of paths based at least in part on the respective output gradient determined by respective DNNs of the plurality of DNNs of the reverse-time-order DNN solver,
determining one or more statistical measures of spread based at least in part on the respective initial value, and
modifying at least one of the one or more respective parameters of each of two or more of the plurality of DNNs based on a result of determining the one or more statistical measures of spread;
after the convergence requirement is satisfied, determine an initial time result based at least in part on respective initial values determined by the reverse-time-order DNN solver for the plurality of paths; and
provide at least a portion of the initial time result such that at least one of (a) a program executing on a computing device receives the at least a portion of the initial time result as input or (b) a user computing device receives the at least a portion of the initial time result and provides a representation of the at least a portion of the initial time result via an interactive user interface provided via a display of the user computing device.

16. The apparatus of claim 15, wherein determining the expected value corresponding to the particular date based on the one or more criteria comprises comparing the expected value to a call value of a callable instrument corresponding to the particular date.

17. The apparatus of claim 16, wherein the one or more criteria are satisfied when (a) the expected value is less than the call value when a holder of the callable instrument has a right to exercise the callable instrument on the particular date or (b) the expected value is greater than the call value when an issuer of the callable instrument has a right to exercise the callable instrument on the particular date.

18. (canceled)

19. The apparatus of claim 15, wherein the regression analysis is a least square regression analysis.

20. The apparatus of claim 19, wherein the least square regression analysis determines an expected value at the particular date based on respective values of the one or more underlying entities at the particular date.

21. The method of claim 1, wherein the regression analysis is performed over each of the one or more paths to determine the expected value.

22. The method of claim 1, wherein the array of dates comprises a plurality of particular dates and the reverse-time-order DNN solver comprises a plurality of reset functions, each reset function corresponding to a respective one of the plurality of particular dates.

23. The method of claim 1, wherein each of the plurality of paths comprises a same initial set of underlying entities.

24. The method of claim 1, wherein the model computing device comprises solver circuitry comprising one or more graphical processing units (GPUs) and configured to execute the reverse-time-order DNN solver.
